(19) United States
(12) Patent Application Publication
(10) Pub. No.: US 2024/0392448 A1
(43) Pub. Date: Nov. 28, 2024

(54) COMPOSITIONS FOR REMOVAL AND ELECTROREDUCTIVE CONVERSION OF CARBON DIOXIDE TO CARBON AND RELATED SYSTEMS AND METHODS

(71) Applicant: Massachusetts Institute of Technology, Cambridge, MA (US)

(72) Inventors: Lev E. Bromberg, Salem, MA (US); Trevor Alan Hatton, Sudbury, MA (US); Michael P. Nitzsche, Plainfield, NJ (US)

(73) Assignee: Massachusetts Institute of Technology, Cambridge, MA (US)

(21) Appl. No.: 18/689,378

(22) PCT Filed: Aug. 19, 2022
(86) PCT No.: PCT/US2022/040868

§ 371 Date: Mar. 5, 2024

Related U.S. Application Data
(60) Provisional application No. 63/241,122, filed on Sep. 7, 2021.

(51) Int. Cl. C25B 1/135; B01J 20/04; C01B 32/05; C25B 1/50

(52) U.S. Cl. CPC C25B 1/135; B01J 20/043; C01B 32/05; C25B 1/50; B01J 2220/42

(57) ABSTRACT

Compositions for removal and electroreductive conversion of carbon dioxide to carbon, and related systems and methods, are generally described. Certain aspects are related to the removal of carbon dioxide and its electrolytic conversion to carbon using sorbents that include salts in molten form.

### RELATED APPLICATIONS

This application claims priority under 35 U.S.C. § 119(e) to U.S. Provisional Patent Application No. 63/241,122, filed Sep. 7, 2021, and entitled “Molten Salt Compositions for Removal and Electroreductive Conversion of Carbon Dioxide to Carbon,” which is incorporated herein by reference in its entirety for all purposes.

### TECHNICAL FIELD

Compositions for removal and electroreductive conversion of carbon dioxide to carbon, and related systems and methods, are generally described.

### BACKGROUND

There is an urgent need to stem release of carbon dioxide (CO₂) worldwide by developing carbon capture and conversion technologies, including post-combustion carbon capture and conversion technologies. Accordingly, improved materials, systems, and methods for capturing CO₂ are highly sought-after.

### SUMMARY

This Summary introduces a selection of concepts in simplified form that are described further below in the Detailed Description. This Summary neither identifies key or essential features, nor limits the scope, of the claimed subject matter.

In one aspect, a composition is described, the composition comprising a sequestration material comprising an alkali metal borate and/or an alkaline earth metal borate, wherein at least about 0.1% of the total mass of sequestration material is made up of a carbonate.

In one aspect, a composition is described, the composition comprising a sequestration material comprising an alkali metal and/or an alkaline earth metal, borate anions, and carbonate anions, wherein at least 0.1% of the total mass of sequestration material is made up of carbonate anions; and wherein at least 0.1% of the total mass of the sequestration material is made up of borate anions.

In another aspect, a method is described, the method comprising within an electrolytic cell comprising a molten material comprising a molten alkali metal borate salt and/or a molten alkaline earth metal borate salt in an amount of at least 10 wt %: electrolytically forming carbon at a cathode of the electrolytic cell.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1A is a schematic diagram of a system configured to perform electrolysis using a sequestration material, according to some embodiments;

FIG. 1B is a schematic diagram of a system where carbon has been deposited on an electrode after performing electrolysis using a sequestration material, according to some embodiments;

FIG. 2 shows a DSC heating endotherm of carbonate Li_{0.62}K_{0.38}CO₃ at 10 deg/min, in accordance with some embodiments.

FIG. 3 is a DSC heating endotherm of borate (Li_{0.5}Na_{0.5})ₓB₁₋ₓO_{1.5-x} (x=0.75) at 10 deg/min, in accordance with certain embodiments. The borate was equilibrated with ambient air and contained hydrate water.

FIG. 4 is a DSC heating/cooling thermogram of the borate/carbonate blend (Sample No. 3 in Table 1), in accordance with some embodiments. The heating and cooling rate was 10 deg/min.

FIG. 5 shows TGA isotherm kinetics of representative borate/carbonate blends in N₂/CO₂ atmosphere at 550° C., in accordance with certain embodiments. The numbers stand for nominal molar concentration of borate (see Example 3 for preparation details).

FIG. 6 shows a schematic and photographs of a reactor for CO₂ electrolysis, in accordance with some embodiments.

FIG. 7 are photographs showing the results of the CO₂ electrolysis in borate/carbonate blends as described in Example 3, in accordance with some embodiments. Pictured are galvanized steel cathode before and after electrolysis, nickel anode before and after electrolysis, and a suspension of carbonaceous product in water obtained by sonication of the cathode that underwent electrolysis.

FIG. 8 shows representative cyclic voltammograms (CV) of a galvanized steel cathode in molten borate and carbonate blend (nominal borate:carbonate mol ratio, 1:1, see Sample No. 3 in Table 1, Example 3), in accordance with some embodiments. Borate: (Li_{0.5}Na_{0.5})ₓB₁₋ₓO_{1.5-x}; x=0.75; carbonate: Li_{0.62}K_{0.38}CO₃. Anode: nickel crucible; temperature: 550° C. The potential scan started cathodically from 0 V, and the reduction and oxidation sweep directions are shown by arrows (IUPAC convention). Solid and dotted lines show three consecutive scans (scan rate, 10 mV/s) measured under nitrogen and CO₂ purge, respectively. Designations A and C stand for anodic and cathodic peak potentials, respectively.

FIG. 9 shows representative XRD patterns of the products of CO₂ electrolysis conducted in molten Li, K carbonate (Sample 5 In Table 1, nominal content of borate. 0 mol %), carbonate and borate blend (nominal molar carbonate/borate ratio, 50:50. Sample 3 in Table 1), and in Li, Na borate (nominal content of borate. 100 mol %), in accordance with some embodiments. Borate: (Li_{0.5}Na_{0.5})ₓB₁₋ₓO_{1.5-x}; x=0.75; carbonate: Li_{0.62}K_{0.38}CO₃. Temperature: 550° C. Cathode: galvanized steel, anode: Ni crucible. Current density on the cathode: 120 mA/cm². Other conditions are described in Example 6. Numbers stand for nominal molar borate content; dotted vertical line shows graphitic peaks at 26.2 degrees.

FIG. 10 shows XRD patterns of the products of CO₂ electrolysis conducted at 600° C. in molten borate: (Li_{0.5}Na_{0.5})ₓB₁₋ₓO_{1.5-x}; x=0.75, in accordance with some embodiments. Anode, nickel crucible; cathode, galvanized steel. Current density on the cathode: 120 mA/cm². Other conditions are described in Example 7. Dotted vertical lines show peaks at 10.6, 26.2, 43, and 44.3 degrees.

FIG. 11 shows transmission electron microphotograph (TEM) of the product of CO₂ electrolysis conducted in borate/carbonate blend, according to some embodiments.

FIG. 12 shows scanning electron microphotograph (SEM) of the product of CO₂ electrolysis conducted in borate/carbonate blend, according to some embodiments.

FIG. 13 shows the effect of the molten borate/carbonate blend composition on the Coulombic efficiency (Cₑ) of the CO₂ electrolysis and the CO₂ uptake (U_{c}) at 550° C., in accordance with some embodiments. Borate: (Li_{0.5}Na_{0.5})·B₁₋ₓO_{1.5-x}; x=0.75; carbonate: Li_{0.62}K_{0.38}CO₃. Arrow shows estimate of the optimal melt composition.

FIG. 14 shows the thermogravimetric analysis (TGA) heating ramp (10° C./min) of as-made carbonate (Li_{1.24}K_{0.76}CO₃), borate (Li_{1.5}Na_{1.5}BO₃), and as-made and pre-treated blend (1:1 mol/mol, sample No. 3 in Table 1) in nitrogen atmosphere, according to certain embodiments. The blend sample was pre-treated by its equilibration at 600° C. in N₂ atmosphere for 1 h. Numbers stand for nominal initial content of borate (mol %) in the samples.

FIG. 15 shows differential scanning calorimetry (DSC) melting endotherms on 10° C./min heating of the carbonate (Li_{1.24}K_{0.76}CO₃) and borate (Li_{1.5}Na_{1.5}BO₃) and their blends in nitrogen atmosphere, in accordance with some embodiments. Numbers indicate nominal initial content of borate (mol %) in the blends. Endotherms were shifted along the heat flow axis for the presentation clarity, while preserving the original scale. Solid and dashed lines represent endotherms obtained using a Discovery DSC 250 (sealed pans) and Q600 (open to nitrogen atmosphere), respectively.

FIG. 16 shows, in accordance with some embodiments, diffraction patterns of a blend of Li, Na borate (Li_{1.5}Na_{1.5}BO₃) and Li, K carbonate (Li_{1.24}K_{0.76}CO₃) (1:1 mol/mol), as-made (a), the same blend reacted with CO₂ at 550° C., quenched and measured at 25° C. (b) and the same reacted blend as in (b), but re-melted with XRD measured at 550° C. (c). Asterisks mark peaks matching planes of tetragonal Li and Li, Na tetraborate crystalline phase at 20.4°; ovals mark patterns pertaining to lithium metaborate (LiBO₂); and squares designate Li₂CO₃ and LiCO₃ and NaCO₃ crystal patterns.

FIGS. 17A-17B show, in accordance with some embodiments, rotational viscosity of Li, Na borate (Li_{1.5}Na_{1.5}BO₃) and eutectic Li, K carbonate (Li_{1.24}K_{0.76}CO₃) measured at 550° C. and at constant shear rates of 10 and 100 s⁻¹ (FIG. 17A) and the effect of borate concentration on viscosity of Li, Na borate (Li_{1.5}Na_{1.5}BO₃) and eutectic Li, K carbonate (Li_{1.24}K_{0.76}CO₃) blends at 550° C. and at shear rates of 10 and 100 s⁻¹ (FIG. 17B). Numbers denote nominal initial borate concentration (mol %) in the blend. Straight exponent fits (R²>0.98) are shown to guide the viewer.

FIG. 18 shows, in accordance with certain embodiments, CO₂ uptake by Li, Na borate (Li_{1.5}Na_{1.5}BO₃) and its eutectic Li, K carbonate (Li_{1.24}K_{0.76}CO₃) blend (borate/carbonate ratio, 1:1 mol/mol, sample No. 3 in Table 1) under 60 mL/min flow of 100% CO₂ at a heating rate of 0.33° C./min. The CO₂ loading (Q, mmol/g) was calculated as a sample weight fraction (10×W_{f}) gained on the exposure to the CO₂ flow, normalized by the molar mass of CO₂ (44.01 g/mol). Arrows show the temperature datapoint at which the CO₂ uptake was measured to be at maximum (Qₘₐₓ). Tₒₙ is the temperature of the CO₂ uptake onset. Numbers indicate nominal initial borate content.

FIGS. 19A-19B show, in accordance with some embodiments, CO₂ uptake (Q, mmol/g) by molten borate/carbonate blends under the 60 mL/min flow of 100% CO₂ at a heating rate of 5° C./min (FIG. 19A) and dependencies of the maximum CO₂ loading (Qₘₐₓ), temperature of the onset of the loading increase (Tₘₐₓ), and the temperature of the maximum CO₂ loading (Tₘₐₓ) on nominal content of Li, Na borate, in the borate/carbonate blends (FIG. 19B). In the TGA experiments, the blends were first purged of water and CO₂ by exposing them to N₂ flow and ramping the temperature to 600° C. at 5° C./min and then allowing to equilibrate, also under N₂ flow, at 200° C. for 1 h. The CO₂ loading was calculated as a sample weight fraction gained on the exposure to the CO₂ flow, normalized by the molar mass of CO₂ (44.01 g/mol). Numbers indicate nominal initial content of borate (mol %) in the blends.

FIGS. 20A-20B show, in accordance with some embodiments, the effect of cycling on CO₂ uptake by molten Li, Na borate (Li_{1.5}Na_{1.5}BO₃) and eutectic Li, K carbonate (Li_{1.24}K_{0.76}CO₃) blend (borate/carbonate ratio, 1:1 mol/mol) (FIG. 20A) and maximum CO₂ loading in each cycle at t_{cycle}=30 min (Qₘₐₓ, mmol/g) vs cycle number (FIG. 20B). Cycling was conducted via pressure swing operation on repeated switching of the gas stream between 100% CO₂ (p_{CO2}=1 bar) and 100% N₂ (p_{CO2}=0 bar) at 550° C. Cycling consisted of alternating 30 min of CO₂ flow followed by nitrogen flow (60 mL/min) for 30 min, and the salt samples (6 mg) were evenly spread at the bottom of a platinum pan with a temperature 550° C. throughout.

FIGS. 21A-21C show typical CO₂ uptake kinetics in one cycle of the cyclical pressure swing operation at 550° C. (FIG. 21A), initial kinetics of CO₂ uptake by Li, Na borate (Li_{1.5}Na_{1.5}BO₃) and its blend with eutectic Li, K carbonate (Li_{1.24}K_{0.76}CO₃) (borate/carbonate ratio, 1:1 mol/mol) (blend) presented in terms of eqn (11-1) (FIG. 21B), and variation of CO₂ conversion degree by Li, Na borate its blend presented in double logarithmic plot of the Avrami-Erofeyev equation (eqn (11-2)) for CO₂ uptake by over the time period of 0.6 min<t<15 min (FIG. 21C). The data is expressed via the degree of conversion α=Q/Qₘₐₓ, wherein Qₘₐₓ, mmol/g, is the maximum CO₂ loading in the cycle at t_{cycle}=30 min. Molten salts are Li, Na borate (Li_{1.5}Na_{1.5}BO₃) and its blend with eutectic Li, K carbonate (Li_{1.24}K_{0.76}CO₃) (borate/carbonate ratio, 1:1 mol/mol) (blend). Straight lines with R²>0.98 goodness-of-fit for the linear regressions (eqns (11-1 to 11-3) are shown.

FIG. 22 shows, according to certain embodiments, XPS spectra of the original galvanized steel electrode (A), the same electrode utilized in the CO₂ electrolysis at 550° C. in molten Li, K borate/Li, Na carbonate (1:1 mol/mol) blend (B), and the same electrode after cleaning its surface of the CNT deposited during the electrolysis (C).

FIG. 23 shows, according to some embodiments, cyclic voltammograms (CV) of a galvanized steel cathode in a molten borate and carbonate blend (nominal borate: carbonate mol ratio, 1:1). The conditions were as follows: borate: Li_{1.5}Na_{1.5}BO₃, eutectic Li, K carbonate: Li_{1.24}K_{0.76}CO₃, anode: nickel crucible; temperature: 550° C. The potential scan started cathodically from 0 V, and the reduction and oxidation sweep directions are shown by arrows (IUPAC convention). Solid and dotted lines show three consecutive scans (scan rate, 10 mV/s) measured under nitrogen and CO₂ purge, respectively, with designations A and C standing for anodic and cathodic peak potentials, respectively.

FIG. 24 shows, according to certain embodiments, the effect of the molten borate/carbonate blend composition on the Coulombic efficiency (Cₑ) of the CO₂ electrolysis and maximum CO₂ uptake (Qₘₐₓ) at 550° C. The following were used: borate: Li_{1.5}Na_{1.5}BO₃, eutectic Li, K carbonate: Li_{1.24}K_{0.76}CO₃.

FIG. 25 shows, in accordance with some embodiments, representative XRD patterns of the products of CO₂ electrolysis conducted in molten Li, K carbonate (Li_{1.24}K_{0.76}CO₃ nominal content of borate, 0 mol %) in borate/carbonate blend (nominal molar carbonate/borate ratio, 1:1), and in Li, Na borate (Li_{1.5}Na_{1.5}BO₃, nominal content of borate, 100 mol %). The following conditions were used: borate: Li_{1.5}Na_{1.5}BO₃, eutectic Li, K carbonate: Li_{1.24}K_{0.76}CO₃, temperature: 550° C., cathode: galvanized steel, anode: Ni crucible, current density on the cathode: 120 mA/cm². Numbers stand for nominal molar borate content. Dotted vertical line shows graphitic peaks at 26.2 degrees.

FIGS. 26A-26B show, in accordance with certain embodiments, TEM (FIG. 26A) and SEM (FIG. 26B) microphotographs of MWCNT found in the products of CO₂ electrolysis conducted in borate (Li_{1.5}Na_{1.5}BO₃) and eutectic carbonate (Li_{1.24}K_{0.76}CO₃) blend (1:1 mol/mol) at 550° C.

### DETAILED DESCRIPTION

Compositions for removal and electroreductive conversion of carbon dioxide to carbon, and related systems and methods, are generally described. Certain aspects are related to the removal of carbon dioxide and its electrolytic conversion to carbon using sorbents that include salts in molten form.

In certain aspects, molten salt compositions for carbon dioxide removal and electrochemical conversion to carbon and related methods are generally described.

Alkali metal carbonates comprising mixtures of at least 10 wt % or higher alkali metal borate or metaborate salt compositions that are molten below 750° C. and simultaneously applied to capture CO₂ from the environment and electrolytically convert said captured CO₂ into carbon are not known in the prior art.

In the present invention, we serendipitously discovered that at certain temperatures and current densities, molten alkali metal borate compositions with melting temperatures below 700° C. can electrolytically convert dissolved CO₂ to carbon. Preferably, said carbon product is in the form of multiwall carbon nanotubes (CNT).

Capture of carbon dioxide (CO₂) from the environment using sequestration materials comprising alkali metal borate and alkali metal carbonate, and related materials, systems, and methods, are generally described. For the purposes of the present invention, borates are salts comprising the borate ion (BO₃³⁻) and metal ions; carbonates are salts containing the carbonate ion (CO₃²⁻) and ions of metals. Consistent with this, for the purposes of the present disclosure, the “borate anion” is BO₃³⁻. For the purposes of the present disclosure, an alkali metal borate is a combination of at least one alkali metal and BO₃³⁻, and an alkaline earth metal borate is a combination of at least one alkaline earth metal and BO₃³⁻. Carbonates can be thought of as carbon dioxide derivatives. In certain embodiments of the borate and carbonate sequestration materials described herein are high capacity sequestration materials effective in the production of carbon from CO₂ through electrolysis.

In certain embodiments of the sequestration materials, the materials comprise mixed salts of lithium, sodium, and potassium borates and carbonates. In one preferred embodiment of the sequestration materials, the materials comprise blends of mixed Li, Na borate and eutectic Li,K carbonate. In certain preferred embodiments of the sequestration materials, the materials comprise 10 mol % or more of borate salt relative to carbonate salt in the molten state. In one preferred embodiment of the sequestration materials, the materials comprise 50 to 60 mol % of borate salt relative to carbonate salt in the molten state.

According to certain preferred embodiments, the sequestration material is in the liquid state at temperatures in the above 500° C. and below 700° C. range. One embodiment is a method for producing carbon nanomaterial comprising performing electrolysis in the above 500° C. and below 700° C. temperature range between an electrolysis anode and an electrolysis cathode in a molten, liquid borate and molten carbonate electrolyte to generate carbon nanotubes (CNT) on the cathode.

Without being bound by any theory, it is believed that the following chemical reactions generally proceed during the sequestration of carbon dioxide by molten lithium borate (e.g., when used as a sequestration material):

4Li₃BO₃+3CO₂↔3Li₂CO₃+Li₆B₄O₉ (1)

4Li₃BO₃+5CO₂↔5Li₂CO₃+Li₂B₄O₇ (2)

Li₃BO₃+CO₂↔Li₂CO₃+LiBO₂ (3)

2Li₃BO₃+3CO₂↔3Li₂CO₃+B₂O₃ (4)

As is shown above, it is believed that the sequestration of CO₂ by Li₃BO₃ results in the reversible formation of lithium carbonate (Li₂CO₃), lithium metaborate (LiBO₂) and lithium oxide (Li₂O)-boron oxide (B₂O₃) binary compounds such as Li₆B₄O₉ and Li₂B₄O₇. The electrolytic conversion of CO₂ in molten carbonates, and preferably lithium carbonates, into value-added carbon products such as carbon nanotubes (CNT) and graphene is one method that has been demonstrated.

Without being bound by any theory, it is believed that the following electrochemical reactions generally proceed during the CO₂ electrolysis in molten lithium carbonate as the electrolytic material: Formation of carbonate ions:

i₂CO₃₍ₘₒₗₜₑₙ₎↔2Li⁺CO₃²⁻ (5)

### Four-Electron Reduction of the Carbonate Ions to Carbon on Cathode:

CO₃²⁻+4e⁻→C+3O²⁻ (6)

### Continuous Formation of Oxygen on the Anode:

2O²⁻−4e⁻→O₂ (7)

The production of carbon in the form of CNT by electrolysis in Li₂CO₃ occurs together with the production of oxygen and lithium oxide:

Li₂CO_{3(liquid)}→C_{(CNT)}+Li₂O_{(dissolved)}+O_{2(gas)} (8)

Li₂CO₃ is consumed by the electrolysis and is continuously replenished by reaction of excess Li₂O (formed electrolysis product) with the CO₂ supplied:

Li₂O_{(dissolved)}+CO_{2(atmospheric,dissolved)}→Li₂CO₃₍ₘₒₗₜₑₙ₎ (9)

Formation of oxygen during electrolytic conversion of CO₂ can be advantageous and can make the process environmentally sustainable. Capture of CO₂ (reaction (9)) can provide for CO₂ removal from the environment by the molten salt.

Electrolytic conversion of CO₂ to carbon (reaction (6)), and preferably to carbon nanotubes or graphene can produce value-added products and can provide for lowering the costs of CO₂ capture and utilization.

Disadvantageously, the melting of lithium carbonate that is necessary for the carbonate ions formation (reaction (5)), when carbonate is used alone, occurs at high temperature of 723° C., whereas the decomposition of lithium carbonate and formation of lithium oxide (Li₂O) occurs at temperatures above 1200° C. or higher. The presence of Li₂O from lithium carbonate is a condition for CO₂ capture by molten carbonates (reaction (9)).

Without the presence of metal oxides in the molten alkali metal carbonates, when said carbonates are used alone, the capacity of said molten carbonates to capture CO₂ from the environment is generally low, and therefore, the subsequent electrolytic CO₂ conversion to the value-added carbon products is limited in scale and inefficient. Therefore, lithium carbonates generally cannot be utilized, when used alone, as reversible CO₂ sorbents at medium temperatures below 750° C. and are disadvantageous for the purposes of the present disclosure.

In certain embodiments, compositions of lithium and sodium and/or lithium and potassium carbonates can be used that advantageously possess lower melting temperatures, which are defined as “eutectic.”

Alkali metal carbonates comprising mixtures of at least 10 wt % or higher alkali metal borate or metaborate salt compositions that are molten below 750° C. and simultaneously applied to capture CO₂ from the environment and electrolytically convert said captured CO₂ into carbon are not believed to be known in the prior art. In the present invention, we serendipitously discovered that at certain temperatures and current densities, molten alkali metal borate compositions with melting temperatures below 700° C. can electrolytically convert dissolved CO₂ to carbon. Preferably, said carbon product is in the form of multiwall carbon nanotubes (CNT).

According to some embodiments, the sequestration material is capable of interacting with carbon dioxide such that a relatively large amount of carbon dioxide is sequestered. Interaction between the sequestration material and carbon dioxide can involve a chemical reaction, adsorption, and/or diffusion. In some embodiments, at least a portion of the carbonate is formed by sequestering carbon dioxide.

In some embodiments, the sequestration material is capable of interacting with carbon dioxide such that at least 0.5 mmol of carbon dioxide is sequestered per gram of the sequestration material. In some embodiments, the sequestration material is capable of interacting with carbon dioxide such that at least 1.0 mmol, at least 2.0 mmol, at least 3.0 mmol, at least 4.0 mmol, or at least 5.0 mmol of carbon dioxide is sequestered per gram of the sequestration material. In some embodiments, the sequestration material is capable of interacting with carbon dioxide such that less than or equal to 10.0 mmol, less than or equal to 9.0 mmol, less than or equal to 8.0 mmol, less than or equal to 7 mmol, or less than or equal to 6 mmol of carbon dioxide is sequestered per gram of the sequestration material. Combinations of the above-referenced ranges are also possible (e.g., between or equal to 0.5 mmol per gram and 10.0 mmol per gram, between or equal to 2.0 mmol per gram and 8.0 mmol per gram, between or equal to 4.0 mmol per gram and 7.0 mmol per gram). Other ranges are also possible.

According to some embodiments, the sequestration material is capable of interacting with carbon dioxide such that a relatively large amount of carbon dioxide is sequestered over a relatively short period of time. For example, in some embodiments, the sequestration material is capable of sequestering at least 0.5 mmol, at least 1.0 mmol, at least 2.0 mmol, at least 3.0 mmol, at least 4.0 mmol, at least 5.0 mmol and/or less than or equal to 10.0 mmol, less than or equal to 9.0 mmol, less than or equal to 8.0 mmol, less than or equal to 7 mmol, or less than or equal to 6 mmol of carbon dioxide per gram of the sequestration material when the sequestration material is exposed to an environment containing the carbon dioxide for a period of 24 hours or less, 12 hours or less, 8 hours or less, 4 hours or less, 1 hour or less, 30 minutes or less, 10 minutes or less, or 2 minutes or less (and/or, at least 10 seconds, at least 20 seconds, at least 30 seconds, or at least 1 minute). Combinations of the above-referenced ranges are also possible (e.g., at least 10 seconds and less than or equal to 24 hours, at least 20 seconds less than or equal to 12 hours, or at least 30 seconds and less than or equal to 8 hours). Other ranges are also possible.

The amount of carbon dioxide sequestered by a sequestration material can be determined, for example, using thermogravimetric analysis.

For the purposes of certain embodiments of the present invention, said molten alkali metal borate compositions are reacted with CO₂ prior to the electrolysis, henceforth comprising molten alkali metal carbonates. Preferably, said molten alkali carbonates comprise lithium carbonate present in the molten salt at 0.1 wt % concentration or higher (e.g., greater than or equal to 5 wt %, greater than or equal to 10 wt %). In some embodiments, said reaction of the molten alkali carbonate with CO₂ occurs by the capture of said CO₂ from the environment by direct contact of CO₂ gas or CO₂-containing gas mixtures with the molten composition. In certain embodiments, said gas mixtures comprise air, flue gas, cement plant exhaust, rotary kiln exhaust, cooler exhaust, industrial or power plant exhaust, automotive exhaust, and the like.

Preferably, said alkali metal borate compositions contain mixed lithium and sodium borates. In some embodiments, said alkali metal borate compositions comprise lithium, 12.2 wt %; sodium, 40.5 wt %; boron, 4.8 wt %; and oxygen, 21 wt %.

For the purposes of the present invention, in certain embodiments, eutectic compositions of carbonates utilized in electrolytic conversion of CO₂ are molten at temperatures below 600° C., and most preferably at temperatures at or below 550° C. Advantageously, said molten eutectic compositions of carbonates are fully miscible with alkali metal borate compositions in their molten state. Further, in accordance with certain embodiments, said mixed borate and carbonate compositions dissolve lithium oxide Li₂O when molten.

One preferred mode of the present invention comprises (i) blending of eutectic mixed lithium, potassium carbonates and lithium, sodium borates at ambient temperature, (ii) loading the blend into electrolysis reactor, (iii) equilibrating said loaded reactor at temperatures in the 500-700° C. range, thereby melting said salt mixtures, (iv) purging the reactor with CO₂-containing gas for certain period of time, again at temperatures in the 500-700° C. range, and (v) performing electrolysis between an electrolysis cathode and an electrolysis anode, in a molten borate/carbonate electrolyte to generate carbon nanomaterial on the cathode in the temperature range of 500-700° C. Preferably, the electrolysis anode consists of nickel and the electrolysis cathode, of galvanized steel. In some embodiments, current densities at the cathode in the process of CO₂ electrolysis are 100 mA/cm² or higher.

In some embodiments, a sequestration material (e.g., a sequestration material comprising a mixture of a borate salt and a carbonate salt) is exposed to carbon dioxide under conditions favoring sequestration of carbon dioxide. For example, in some embodiments, the sequestration material comprises a salt in molten form, and the molten salt is exposed to the environment containing carbon dioxide in a manner facilitating contact between the two, whereby the carbon dioxide is sequestered by the sequestration material.

Uptake of carbon dioxide by the sequestration material in accordance with some embodiments can be at desirable levels. The sequestration material may comprise a salt in molten form comprising an alkali metal and/or an alkaline earth metal cation, a boron oxide anion (e.g., a borate, a metaborate), a carbonate anion, and/or a dissociated form thereof. In some embodiments, uptake by the sequestration material may be as much as or greater than 0.5 mmol of carbon dioxide per gram of sequestration material (e.g., within 1 minute of exposure to an environment containing carbon dioxide). Advantageously, the inclusion of carbonate and a borate may increase sequestration kinetics and/or subsequent reduction of the carbon dioxide (e.g., into an elemental carbon-based material such as graphene, and/or carbon nanotubes).

Various embodiments are related to a sequestration material that comprises a salt in molten form, the composition of which salt can be selected to have a low melting temperature relative to other salts such that less energy is required to melt the salt. In addition, the composition of the salt can be selected in order to tune the melting point (e.g., the melting temperature at 1 atm) of the salt, e.g., to approach or match the temperature at which carbon dioxide is exposed and/or emitted from a source of the carbon dioxide.

As noted above, for some embodiments, the sequestration material comprises a salt is in molten form. For example, in some embodiments, a solid salt (e.g., a salt, a double salt) comprising an alkali metal cation and/or an alkaline earth metal cation, a borate, and/or a carbonate (and/or a dissociated forms of thereof) may be heated above its melting temperature which results in the solid transitioning into a liquid state (i.e., a molten form). According to some embodiments, the salt comprising an alkali metal cation and/or an alkaline earth metal cation, a borate, and/or a carbonate (and/or a dissociated forms thereof) is a salt having a melting point between or equal to 550° C. and 750° C. when at atmospheric pressure. Those of ordinary skill in the art would understand that a molten salt is different from a solubilized salt (i.e., a salt that has been dissolved within a solvent).

The sequestration material can have a number of chemical compositions. According to some embodiments, the sequestration material comprises at least one alkali metal and/or alkaline earth metal cation, at least one borate, at least one carbonate, and/or dissociated forms thereof.

The term “alkali metal” is used herein to refer to the following six chemical elements of Group 1 of the periodic table: lithium (Li), sodium (Na), potassium (K), rubidium (Rb), cesium (Cs), and francium (Fr).

In some embodiments, the at least one alkali metal cation comprises cationic lithium (Li), sodium (Na), potassium (K), rubidium (Rb), and/or cesium (Cs). In some embodiments, the at least one alkali metal cation comprises cationic lithium (Li), sodium (Na), and/or potassium (K).

The term “alkaline earth metal” is used herein to refer to the six chemical elements in Group 2 of the periodic table: beryllium (Be), magnesium (Mg), calcium (Ca), strontium (Sr), barium (Ba), and radium (Ra).

In some embodiments, the at least one alkaline earth metal cation comprises cationic beryllium (Be), magnesium (Mg), calcium (Ca), strontium (Sr), barium (Ba), and/or radium (Ra). In some embodiments, the at least one alkaline earth metal cation comprises cationic magnesium (Mg) and/or calcium (Ca).

In some embodiments, the sequestration material comprises at least one other metal cation. In some embodiments, the at least one other metal cation comprises another alkali metal cation, another alkaline earth metal cation, and/or a transition metal cation. In some embodiments, the sequestration material comprises at least two alkali metal cations and/or alkaline earth metals (e.g., 2 alkali metal cations, 2 alkaline earth metal cations, 3 alkali metal cations, 2 alkali metal cations and an alkaline earth metal cation). In some embodiments, the sequestration material comprises cationic lithium and cationic sodium. In some embodiments, the sequestration material comprises cationic lithium and cationic potassium.

The “transition metal” elements are scandium (Sc), yttrium (Y), lanthanum (La), actinium (Ac), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), manganese (Mn), technetium (Tc), rhenium (Re), bohrium (Bh), iron (Fe), ruthenium (Ru), osmium (Os), hassium (Hs), cobalt (Co), rhodium (Rh), iridium (Ir), meitnerium (Mt), nickel (Ni), palladium (Pd), platinum (Pt), darmstadtium (Ds), copper (Cu), silver (Ag), gold (Au), roentgenium (Rg), zinc (Zn), cadmium (Cd), mercury (Hg), and copernicium (Cn).

In some embodiments, it may be advantageous for the sequestration material to comprise an alkali metal and/or alkaline earth metal and, optionally, one other metal cation at a composition at or near a eutectic composition, such that the melting temperature of the sequestration material is lower than the melting temperature of a sequestration material with a different composition of the alkali metal cation and/or alkaline earth metal cation and the, optional, one other metal cation, reducing the energy required to attain the sequestration material in molten form for a carbon dioxide sequestration process.

In some embodiments the sequestration material comprises at least two components (e.g., metal cations, alkaline earth metal cations) that are capable of forming a eutectic composition with each other. As would be understood by one of ordinary skill in the art, a “eutectic composition” is a composition that melts at a temperature lower than the melting points of the composition's constituents. For some eutectic compositions, the liquid phase is in equilibrium with both a first solid phase and a second solid phase different from the first solid phase at the eutectic temperature. A eutectic composition that is cooled from a temperature above the eutectic temperature to a temperature below the eutectic temperature under equilibrium cooling conditions undergoes, in some cases, solidification at the eutectic temperature to form a first solid phase and a second solid phase simultaneously from a liquid. As would also be understood by one of ordinary skill in the art, two components that are capable of forming a eutectic composition with each other are, in some cases, also able to form non-eutectic compositions with each other. Non-eutectic compositions often undergo solidification over a range of temperatures because liquid phases may be in equilibrium with solid phases over a range of temperatures.

In some embodiments, the sequestration material comprises a mixture (e.g., a eutectic mixture) of an alkali metal borate and/or an alkaline earth metal borate and also an alkali metal carbonate. That is, in some embodiments, a sequestration material comprises an alkali metal borate and/or an alkaline earth metal borate mixed with an alkali metal carbonate. In some embodiments, the sequestration material comprises a first salt comprising the alkali metal borate (e.g., Li₃BO₃, (Li_{0.5}Na_{0.5})ₓB₁₋ₓO_{1.5-x} with x=0.75) and/or the alkaline earth metal borate and a second salt comprising the carbonate (e.g., K₂CO₃).

In some embodiments, the sequestration material comprises a relatively high weight percentage of carbonate anions (e.g., paired with cations within the solid form of the sequestration material and/or within the sequestration material in molten form), relative to the total weight of the sequestration material. In some embodiments, greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the total weight of the sequestration material is made up of carbonate anions. In some embodiments, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 15 wt % of the total weight of the sequestration material is made up of carbonate anions. Combinations of the above-referenced ranges are also possible (e.g., greater than or equal to 0.1 wt % and less than or equal to 90 wt %). Other ranges are also possible.

In certain embodiments in which one or more alkali metal carbonates (e.g., Li₂CO₃, K₂CO₃) and/or alkaline earth metal carbonates are present in the sequestration material (e.g., the sequestration material in a solid form, the sequestration material in a molten form), the alkali metal carbonate(s) and/or the alkaline earth metal carbonate(s) may be present in any of a variety of suitable weight percentages, relative to the total weight of the sequestration material. In some embodiments, the total amount of all alkaline earth metal carbonates and all alkali metal carbonates within the sequestration material is greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the total weight of the sequestration material. In some embodiments, the total amount of all alkaline earth metal carbonates and all alkali metal carbonates within the sequestration material is less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 15 wt % of the total weight of the sequestration material. Combinations of the above-referenced ranges are also possible (e.g., greater than or equal to 0.1 wt % and less than or equal to 90 wt %). Other ranges are also possible. In some embodiments, the total amount of all alkaline earth metal carbonates within the sequestration material is greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the total weight of the sequestration material. In some embodiments, the total amount of all alkaline earth metal carbonates within the sequestration material is less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 15 wt % of the total weight of the sequestration material. Combinations of the above-referenced ranges are also possible (e.g., greater than or equal to 0.1 wt % and less than or equal to 90 wt %). Other ranges are also possible. In some embodiments, the total amount of all alkali metal carbonates within the sequestration material is greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the total weight of the sequestration material. In some embodiments, the total amount of all alkali metal carbonates within the sequestration material is less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 15 wt % of the total weight of the sequestration material. Combinations of the above-referenced ranges are also possible (e.g., greater than or equal to 0.1 wt % and less than or equal to 90 wt %). Other ranges are also possible.

In some embodiments, the sequestration material (e.g., the sequestration material in a solid form, the sequestration material in a molten form) includes a particular amount of carbonate anions (e.g., CO₃²⁻), expressed as a mole percentage relative to all other species of the sequestration material. In some embodiments, a mole percent of carbonate anions within the sequestration material is greater than or equal to 0.1 mol %, greater than or equal to 1 wt %, greater than or equal to 5 mol %, greater than or equal to 10 mol %, greater than or equal to 15 mol %, greater than or equal to 20 mol %, greater than or equal to 25 mol %, greater than or equal to 30 mol %, greater than or equal to 40 mol %, greater than or equal to 50 mol %, greater than or equal to 60 mol %, greater than or equal to 70 mol %, greater than or equal to 75 mol %, or greater than or equal to 80 mol % of the total moles of the sequestration material. In some embodiments, a mole percent of carbonate anions within the sequestration material is less than or equal to 80 mol %, less than or equal to 75 mol %, less than or equal to 70 mol %, less than or equal 60 mol %, less than or equal to 50 mol %, less than or equal to 40 mol %, less than or equal to 30 mol %, less than or equal to 25 mol %, less than or equal to 20 mol %, less than or equal to 15 mol %, or less than or equal to 10 mol % of the total moles of the sequestration material. Combinations of the above-referenced ranges are also possible (e.g., greater than or equal to 10 mol % and less than or equal to 80 mol %). Other ranges are also possible. By way of illustration, if a sequestration material is a mixture of 1 mole of Li_{1.5}Na_{1.5}BO₃ and 1 mole of K₂CO₃ and the sequestration material is in molten form, then the mole % of carbonate anions in the sequestration material would be [(1 mole CO₃²⁻)/(1 mole CO₃²⁻+1.5 mole Li⁺+1.5 mole Na⁺+1 mole BO₃³⁻+2 mole K⁺)]*100=14.29 mol % CO₃²⁻. For comparison, the mole percent of potassium in this hypothetical sequestration material in a molten form would be [(2 mole K⁺/(1 mole CO₃²⁻+1.5 mole Li⁺+1.5 mole Na⁺+1 mole BO₃³⁻+2 mole K⁺)]*100=28.57 mol % K⁺.

In some embodiments, the sequestration material comprises a relatively high weight percentage of borate anions (e.g., paired with cations within the solid form of the sequestration material and/or within the sequestration material in molten form), relative to the total weight of the sequestration material. In some embodiments, greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the total weight of the sequestration material is made up of borate anions. In some embodiments, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 15 wt % of the total weight of the sequestration material is made up of borate anions. Combinations of the above-referenced ranges are also possible (e.g., greater than or equal to 0.1 wt % and less than or equal to 90 wt %). Other ranges are also possible.

In certain embodiments in which one or more alkali metal borates (e.g., Li_{1.5}Na_{1.5}BO₃) and/or alkaline earth metal borates are present in the sequestration material (e.g., the sequestration material in a solid form, the sequestration material in a molten form), the alkali metal borate(s) and/or the alkaline earth metal borate(s) may be present in any of a variety of suitable weight percentages, relative to the total weight of the sequestration material. In some embodiments, the total amount of all alkaline earth metal borates and all alkali metal borates within the sequestration material is greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the total weight of the sequestration material. In some embodiments, the total amount of all alkaline earth metal borates and all alkali metal borates within the sequestration material is less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 15 wt % of the total weight of the sequestration material. Combinations of the above-referenced ranges are also possible (e.g., greater than or equal to 0.1 wt % and less than or equal to 90 wt %). Other ranges are also possible. In some embodiments, the total amount of all alkaline earth metal borates within the sequestration material is greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the total weight of the sequestration material. In some embodiments, the total amount of all alkaline earth metal borates within the sequestration material is less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 15 wt % of the total weight of the sequestration material. Combinations of the above-referenced ranges are also possible (e.g., greater than or equal to 0.1 wt % and less than or equal to 90 wt %). Other ranges are also possible. In some embodiments, the total amount of all alkali metal borates within the sequestration material is greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the total weight of the sequestration material. In some embodiments, the total amount of all alkali metal borates within the sequestration material is less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 15 wt % of the total weight of the sequestration material. Combinations of the above-referenced ranges are also possible (e.g., greater than or equal to 0.1 wt % and less than or equal to 90 wt %). Other ranges are also possible.

In some embodiments, the sequestration material (e.g., a sequestration material in a solid form, a sequestration material in molten form) includes a particular amount of borate anions (e.g., BO₃³⁻), expressed as a mole percentage. In some embodiments, a mole percent of borate anions within the sequestration material is greater than or equal to 10 mol %, greater than or equal to 15 mol %, greater than or equal to 20 mol %, greater than or equal to 25 mol %, greater than or equal to 30 mol %, greater than or equal to 35 mol %, greater than or equal to 50 mol %, greater than or equal to 60 mol %, greater than or equal to 70 mol %, greater than or equal to 75 mol %, greater than or equal to 80 mol %, or greater than or equal to 90 mol % of the total moles of the sequestration material. In some embodiments, a mole percent of borate within the sequestration material is less than or equal 90 mol %, less than or equal to 80 mol %, less than or equal to 75 mol %, less than or equal to 70 mol %, less than or equal to 60 mol %, less than or equal to 40 mol %, less than or equal to 35 mol %, less than or equal to 30 mol %, less than or equal to 25 mol %, or less than or equal to 20 mol % of the total moles of the sequestration material. Combinations of the above-referenced ranges are also possible (e.g., greater than or equal to 10 mol %, and less than or equal to 90 mol %). Other ranges are possible.

One or more metals (e.g., alkali metal, alkaline earth metal, and/or cationic forms thereof) of the sequestration material may each be present at a particular weight relative to the total weight of the sequestration material. In some embodiments, the total of all metals within the sequestration material is greater than or equal to 10 wt %, greater than or equal to 20 wt %, greater than or equal to 30 wt %, greater than or equal to 40 wt %, or greater than or equal to 50 wt % of the total weight of the sequestration material. In some embodiments, the total of all metals within the sequestration material is less than or equal to 50 wt %, less than or equal to 40 wt %, less than or equal to 30 wt %, less than or equal to 20 wt %, or less than or equal to 10 wt % of the total weight of the sequestration material. Combinations of the above-referenced ranges are also possible (e.g., greater than or equal to 10 wt % and less than or equal to 50 wt %). Other ranges are possible.

In some embodiments, the sequestration material (e.g., a sequestration material in molten form) includes a particular amount (moles) of one or more metals (e.g., alkali metal, alkaline earth metal, and/or cationic forms thereof). In some embodiments, a mole percent of one or more metals of the sequestration material (and/or the mole percent of the total of all metals within the sequestration material) is greater than or equal to 20 mol %, greater than or equal to 25 mol %, greater than or equal to 30 mol %, greater than or equal to 35 mol %, greater than or equal to 50 mol %, greater than or equal to 60 mol %, or greater than or equal to 70 mol %. In some embodiments, a mole percent of one or more metals of the sequestration material (and/or the mole percent of the total of all metals within the sequestration material) is less than or equal 90 mol %, less than or equal to 80 mol %, less than or equal to 70 mol %, less than or equal to 60 mol %, less than or equal to 40 mol %, less than or equal to 35 mol %, less than or equal to 30 mol %, less than or equal to 25 mol %, or less than or equal to 20 mol %. Combinations of the above-referenced ranges are also possible (e.g., greater than or equal to 20 mol %, and less than or equal to 90 mol %). Other ranges are possible.

The amounts (e.g., mol %, wt %) of the various species described above (e.g., borates, carbonates, and/or alkali metal and/or alkaline earth metal) can be determined via thermogravimetric analysis as described elsewhere herein.

In some embodiments, the sequestration material has a particular ratio of carbonate anions and borate anions. In some embodiments, within the sequestration material, the ratio of carbonate anions (in salt or dissociated form) to borate anions (in salt or dissociated form) is greater than or equal to 0.1:1, greater than or equal to 0.2:1, greater than or equal to 0.3:1, greater than or equal to 0.5:1, greater than or equal to 0.7:1, greater than or equal to 0.9:1, greater than or equal to 1:1, greater than equal to 1.1:1, greater than or equal to 1.2:1, greater than or equal to 1.5:1, greater than or equal to 1.7:1, greater than or equal to 2:1, greater than or equal to 2.5:1, or greater than or equal to 3:1. In some embodiments, within the sequestration material, the ratio of carbonate anions (in salt or dissociated form) to borate anions (in salt or dissociated form) is less than or equal to 10:1, less than or equal to 8:1, less than or equal to 5:1, less than or equal to 3:1, less than or equal to 2.5:1, less than or equal to 2:1, less than or equal to 1.7:1, less than or equal to 1.5:1, less than or equal to 1.2:1, less than or equal to 1:1, less than or equal to 0.9:1, less than or equal to 0.7:1, less than or equal to 0.5:1, less than or equal to 0.3:1, less than or equal to 0.2:1, or less than or equal to 0.1:1. Combinations of the above-referenced ranges are also possible (e.g., greater than or equal to 0.1:1 and less than or equal to 3:1). Other ranges are possible.

In some embodiments, it may be advantageous to have a sequestration material comprise anionic BO₃ and/or a dissociated form thereof. A potential advantage of anionic BO₃ and/or a dissociated form thereof may include a greater carbon dioxide uptake capacity of the sequestration material during exposure to an environment containing carbon dioxide, relative to a sequestration material having the same alkali metal cation (and/or any other cations) and anionic B₂O₅ and/or a dissociated form thereof.

In some embodiments, the fractional stoichiometry of a borate of the sequestration material described herein can be expressed as MₓB₁₋ₓO_{y}, wherein x is a mixing ratio and is between zero and 1. In some embodiments, the fractional stoichiometry is that of the sequestration material in solid form, e.g., before melting. In some embodiments, the fractional stoichiometry is that of the salt in molten form, e.g., after melting. For some embodiments, y=1.5−x. “M” in this formula refers to the metal cation(s) (e.g., an alkali metal cation, an alkaline earth metal cation, a combination of an alkali metal and/or alkaline earth metal cations) in a sequestration material described herein. For example, in some embodiments, the fractional stoichiometry of a component of the sequestration material described herein can be expressed as AₓB₁₋ₓO_{y}, where 0<x<1 and A is an alkali metal (e.g., Li, Na, K). In some embodiments, y=1.5−x.

As used herein, the term “mixing ratio” of an alkali metal cation or combination of metal cations in a sequestration material refers to the ratio of moles of metal cation(s) in a sequestration material to the total of moles of metal cation(s) plus moles of boron in the sequestration material. For example, the mixing ratio of sodium in Na₃BO₃ is 3/(3+1)=0.75; the mixing ratio of alkali metals in (Li_{0.5}Na_{0.5})₃BO₃ is (0.5*3+0.5*3)/(3+1)=0.75. In some embodiments, the mixing ratio is at least 0.5, at least 0.6, or at least 0.667. In some embodiments, the mixing ratio is at most 0.9, at most 0.835, at most 0.8, at most 0.75, or at most 0.7. Combinations of the above-referenced ranges are also possible (e.g., between or equal to 0.5 and 0.9, between or equal to 0.6 and 0.8, between or equal to 0.7 and 0.8). Other ranges are also possible. Without wishing to be bound by theory, there may be a mixing ratio (for a certain alkali metal cation or combination of metal cations) below which the carbon dioxide uptake capacity of the sequestration material is less than desirable. Without wishing to be bound by theory, there may be a mixing ratio (for a certain alkali metal cation or combination of metal cations) above which the regeneration efficiency of the sequestration material is less than desirable.

In some embodiments, the sequestration material may comprise a salt in molten form but may also comprise portions of that are not molten. That is to say, complete melting of all of the components of the sequestration material that are present in molten form is not required in all embodiments. In some embodiments, at least 10 wt %, at least 20 wt %, at least 30 wt %, at least 40 wt %, at least 50 wt %, at least 60 wt %, at least 70 wt %, at least 80 wt %, at least 90 wt %, or more of the salt(s) present within the sequestration material is molten. In some embodiments, less than 100 wt %, less than 99 wt %, less than 90 wt %, or less of the salt that is present within the sequestration material is molten. Combinations of the above-referenced ranges are also possible. Other ranges are also possible.

In some embodiments, the sequestration material comprises a double salt. As understood by those skilled in the art, a double sat comprises more than one cation and/or anion. As a non-limiting example of a double salt is (NH₄)₂Fe(SO₄)₂·(H₂O)₆), which comprises two cations, NH⁴⁺, Fe²⁺, and one anion, SO₄²⁻. In some embodiments, the double salt, in solubilized, melted, or otherwise dissociated form, may comprise a mixture of ions (e.g., Li⁺, Na⁺, K⁺, Mg²⁺, Ca²⁺, BO₃³⁻, and/or CO₃²⁻), but may form a solid (e.g., upon being cooled, precipitated, or otherwise transformed into a solid) comprising one salt that comprises more than one cation and/or anion. Those skilled in the art will understand that a mixture of borate and carbonate, along with the appropriate counter cations are contemplated, either as mixtures of salts, and/or as one or more double salts.

In some embodiments, a relatively high weight percentage of the sequestration material is made up of carbonate anions, borate anions, alkali metal(s), and/or alkaline earth metal(s) (e.g., in salt form and/or in molten form). In some embodiments, the carbonate anions, borate anions, alkali metal(s), and/or alkaline earth metal(s) may be in ionic forms (e.g., CO₃²⁻, BO₃³⁻, Li⁺, K⁺, Mg²⁺). In some embodiments, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal 95 wt %, greater than or equal to 99 wt %, greater than or equal to 99.9 wt %, or greater than or equal to 99.99 wt % (and/or, in some embodiments, up to 100 wt %) of the sequestration material is made up of carbonate anions, borate anions, alkali metal(s), and/or alkaline earth metal(s) (e.g., in salt form and/or in molten form). In some embodiments, less than or equal to 100 wt %, less than or equal to 99.99 wt %, less than or equal to 99.9 wt %, less than or equal to 99 wt %, less than or equal to 95 wt %, less than or equal to 90 wt %, less than or equal to 80 wt %, less than or equal to 70 wt %, or less than or equal to 60 wt % of the sequestration material is made up of carbonate anions, borate anions, alkali metal(s), and/or alkaline earth metal(s) (e.g., in salt form and/or in molten form). Combinations of the above-referenced ranges are also possible (e.g., greater than or equal to 50 wt % and less than or equal to 100 wt %). Other ranges are possible.

In some embodiments, a relatively high percentage of the sequestration material is in molten salt form (e.g., greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal 95 wt %, greater than or equal to 99 wt %, greater than or equal to 99.9 wt %, or greater than or equal to 99.99 wt % (and/or, in some embodiments, up to 100 wt %)).

In some embodiments, the sequestration material is molten at a particular temperature (e.g., prior to and/or during use in an electrolytic cell, such as the electrolytic cells disclosed elsewhere herein). In some embodiments, the sequestration material is molten at a temperature of greater than or equal to 500° C., greater than or equal to 550° C., greater than or equal to 570° C., greater than or equal to 600° C., greater than or equal to 620° C., greater than or equal to 650° C., greater than or equal to 670° C., greater than or equal to 700° C., greater than or equal to 720° C., or greater than or equal to 750° C. In some embodiments, the sequestration material is molten at a temperature of less than or equal to 750° C., less than or equal to 720° C., less than or equal to 700° C., less than or equal to 670° C., less than or equal to 650° C., less than or equal to 620° C., less than or equal to 600° C., less than or equal to 570° C., less than or equal to 550° C., or less than or equal to 500° C. Combinations of the above-referenced ranges are also possible (e.g., greater than or equal to 500° C. and less than or equal to 750° C.). Other ranges are possible. In certain embodiments, the sequestration material is maintained within any of these temperature ranges during at least a portion (e.g., during at least 10%, at least 25%, at least 50%, at least 75%, at least 90%, at least 95%, at least 99%, or up to 100%) of the time during which electrolysis is performed (e.g., using any of the electrolytic cells described elsewhere herein).

In some embodiments, a sequestration material further comprises an additive. Examples of types of additives that may be included in a sequestration material include, but are not limited, to corrosion inhibitors, viscosity modifiers, wetting agents, high-temperature surfactants, and scale inhibitors. In some embodiments, the sequestration material comprises a plurality of additives (e.g., two, three, four, or more).

In some embodiments, the sequestration material also comprises a hydroxide of an alkali metal and/or alkaline earth metal. For example, in some embodiments, the sequestration material comprises NaOH, KOH, and/or LiOH. For some embodiments, a hydroxide of an alkali metal and/or alkaline earth metal can be formed as a by-product of a reaction between the sequestration material and carbon dioxide.

In some embodiments, electrolysis is performed using the sequestration material, for example, after the sequestration material has been melted and/or after the sequestration material has sequestered at least some carbon dioxide. It has been recognized, within the context of the present disclosure, that the sequestered carbon dioxide may be reduced to other forms of carbon, such as elemental forms of carbon (where the carbon is in its C⁰ state). In some embodiments, electrolysis using the sequestration material produces graphitic carbon, such as graphite, graphene, carbon nanotubes, or other forms of graphitic carbon. In some embodiments, electrolysis using the sequestration material produces carbon nanotubes, and in certain such embodiments, multi-walled carbon nanotubes.

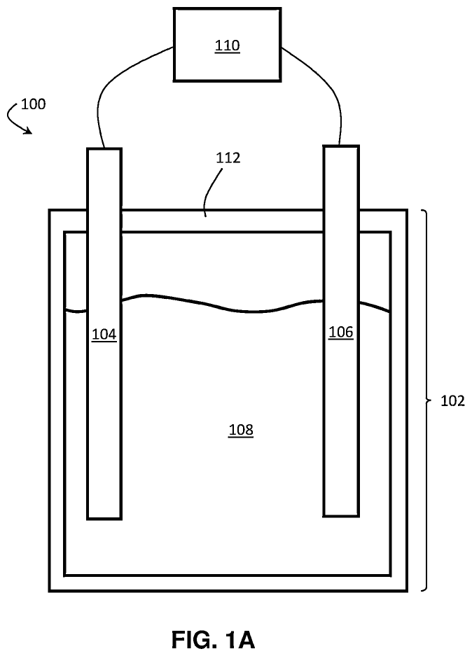

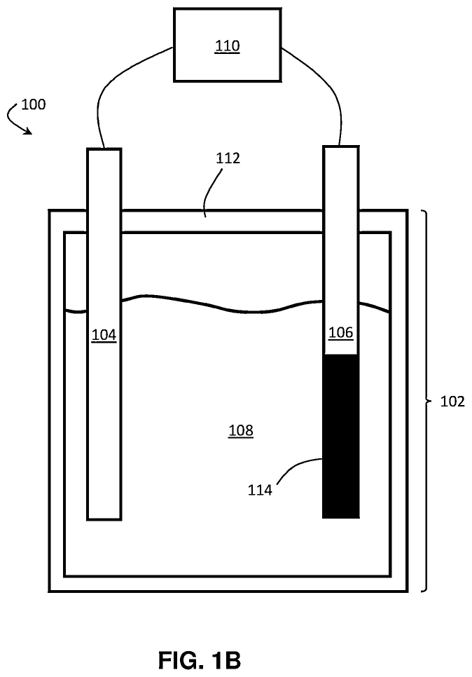

By way of illustration (and not limitation), FIG. 1A schematically depicts a system 100 configured to perform electrolysis using a sequestration material as described elsewhere herein. The system 100 includes an electrolytical cell 102, which comprises an anode 104 and a cathode 106 immersed in an electrolyte 108. Electrolyte 108 can be or comprise the sequestration material that is to be used in the electrolysis, such as any of the sequestration materials described elsewhere herein. In some embodiments, methods of the present disclosure include starting with a solid sequestration material, melting the sequestration material, and using the molten sequestration material in the electrolytic cell (e.g., to sequester CO₂ and/or as an electrolyte). The system 100 also includes a source of electrical energy 110 (e.g., a power source) for providing the electric energy for driving the electrolysis and a container 112 for containing the electrolyte 108 and other components of the system 110.

Upon performing the electrolysis using the sequestration material (e.g., sequestration material that has been melted and that has sequestered at least some carbon dioxide), carbon of the carbon dioxide may be reduced to other forms of carbon. For example, as shown in FIG. 1B, deposited carbon 114 has formed on cathode 106. As noted elsewhere herein, this deposited carbon may comprise graphitic carbon (e.g., carbon nanotubes, or other forms of graphitic carbon). In some embodiments, the deposited carbon can be removed from the cathode (e.g., to revert the system back to a state shown in FIG. 1A).

In some embodiments, the composition (e.g., comprising a sequestration material) is heated until the composition is molten with the gaseous carbon dioxide to produce a molten alkali metal carbonate. In some embodiments, electrolysis between an anode and a cathode in the molten alkali metal carbonate generates carbon material on the cathode. Various embodiments may further comprise separating some or all of the carbon material from the cathode.

In some embodiments, the sequestration material is capable of reversibly sequestering carbon dioxide. For example, in some such embodiments, the sequestration material is configured such that, after the sequestration material sequesters a quantity of carbon dioxide from the surrounding environment, the sequestration material can be exposed to an environment with a lower amount (e.g., a lower partial pressure) of carbon dioxide. For example, in some embodiments, the sequestration material may be configured such that, when fresh sequestration material (i.e., sequestration material that has not taken up CO₂) is exposed to 1 atm of 100% CO₂ it uptakes an amount of CO₂ (referred to as an “uptake step”) and such that, when the sequestration material is subsequently exposed to 1 atm of 100% argon it releases at least a portion of the CO₂ it took up during the uptake step (referred to as a “regeneration step”). In some such embodiments, during the regeneration step, the sequestration material releases at least 50 wt %, at least 75 wt %, at least 90 wt %, at least 95 wt %, at least 99 wt %, or more of the CO₂ it took up in its initial uptake step. In some embodiments, the sequestration material is capable of undergoing at least 10, at least 25, at least 100, or more cycles (i.e., a combination of an uptake step and a regeneration step) and, for each regeneration step, release at least 50 wt %, at least 75 wt %, at least 90 wt %, at least 95 wt %, at least 99 wt %, or more of the CO₂ it took up during the previous uptake step.

The following examples are intended to illustrate certain embodiments of the present invention, but do not exemplify the full scope of the invention.

### Examples

### Example 1—Preparation of Preferred Alkali Metal Carbonate

Lithium carbonate (Li₂CO₃, ACS reagent, ≥99%) and potassium carbonate (K₂CO₃, ACS reagent, ≥99%) were both obtained from Sigma Aldrich Chemical Co. Powderous blend of Li₂CO₃ (21.07 g, 0.285 mol) and K₂CO₃ (24.16 g, 0.175 mol) was ground at ambient temperature using mortar and pestle and was dried on air at 350° C. for 8 h in an electric oven. Following cooling, the resulting eutectic Li,K carbonate (62:38 mol ratio of lithium and potassium carbonates, nominal composition, Li_{0.62}K_{0.38}CO₃) was again ground and kept in a sealed container prior to the use.

### Example 2—Preparation of Preferred Alkali Metal Borate

Lithium hydroxide (LiOH, 98%), sodium hydroxide (NaOH, ≥98%, anhydrous), and boric acid (H₃BO₃, 99.5%) were obtained from Sigma Aldrich Chemical Co. All water utilized was Mill-Q (Millipore) deionized water.

Deionized water (30 mL) was gently added to a powderous mixture of solid LiOH (9.1 g, 0.39 mol), NaOH (15.03 g, 0.39 mol), and H₃BO₃ (15.88 g, 0.26 mol), and the resulting suspension was sonicated for 5 min following by heating at 60° C. while stirring in a sealed bottle. The resulting suspension was allowed to dry at 100° C. on air overnight and the resulting powder was gently ground by mortar and pestle and dried at 400° C. for 4 h. Following cooling, the resulting Li,Na borate (composition, (Li_{0.5}Na_{0.5})ₓB₁₋ₓO_{1.5-x}, x=0.75)) was again ground and kept in a sealed container prior to the use.

### Example 3—Preparation of Blended Borate/Carbonate Compositions

Weighed amounts of Li,K carbonate (Example 1) and Li,Na borate (Example 2) were mixed with a spatula, ground by mortar and pestle for 5 min, dried on air in an electric oven for 3 days at 100° C., and then kept in a sealed vial at ambient temperature prior to the use. Each blend was analyzed for water content using thermogravimetric analysis and the borate content (mol %) was then corrected due to the measured presence of hydrate (clathrate) water. The compositions of the borate-carbonate blends are listed in Table 1.

TABLE 1
Compositions of preferred borate and carbonate blends.
Borate: (Li_{0.5}Na_{0.5})ₓB₁₋ₓO_{1.5-x} (x = 0.75); carbonate: Li_{0.62}K_{0.38}CO₃.

| Sample | Nominal borate | Borate content | Carbonate content |
|---|---|---|---|
| No. | content (mol %) | corrected (mol %) | corrected (mol%) |
| 1 | 100 | 100.0 | 0.0 |
| 2 | 75 | 68.9 | 31.1 |
| 3 | 50 | 48.3 | 51.7 |
| 4 | 25 | 21.4 | 78.6 |
| 5 | 0 | 0.0 | 100.0 |

### Example 4—Melting of Preferred Borate, Carbonate, and Borate/Carbonate Blends

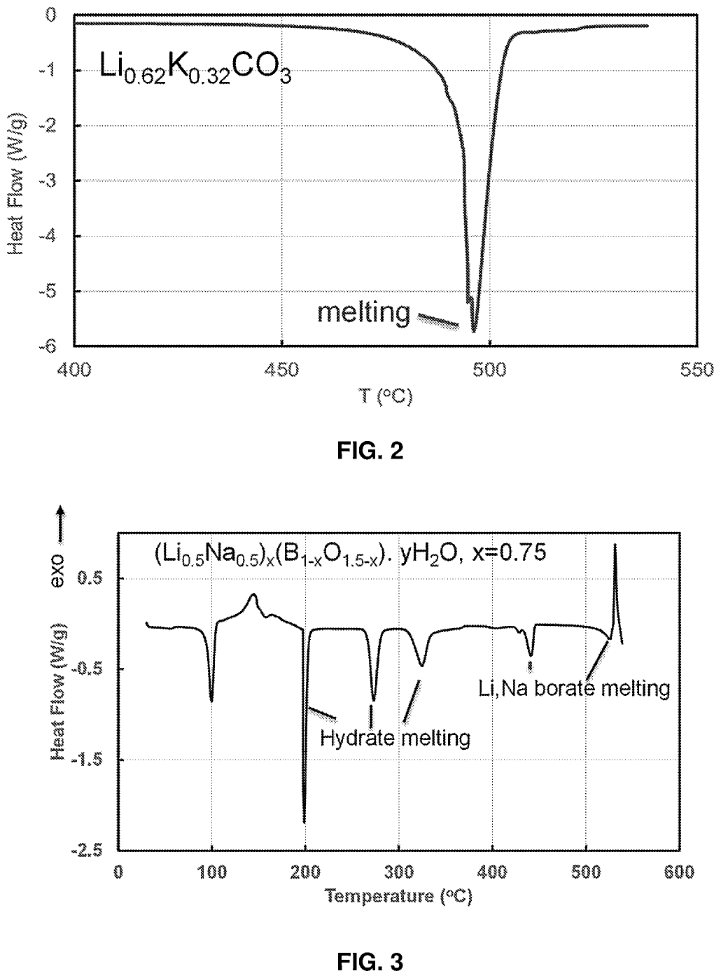

Salt compositions were characterized by differential scanning calorimetry (DSC) and thermogravimetric analysis (TGA) using a Discovery DSC 250 and Q50 TGA models, respectively, both from TA Instruments. Heating and cooling ramp scan rates of 10° C./min were applied; the DSC samples were sealed in aluminum pans and the TGA was ran in nitrogen atmosphere. FIG. 2 shows melting endotherm of the carbonate Li_{0.62}K_{0.38}CO₃, indicating a sharp melting endotherm centered at 496° C. (Example 1). This compound is liquid at temperatures above 500° C.

FIG. 3 shows melting endotherm of borate (Li_{0.5}Na_{0.5})ₓB₁₋ₓO_{1.5-x} (x=0.75) (Example 2). The borate was equilibrated with ambient air and contained hydrate water. The borate composition is molten above 530° C.

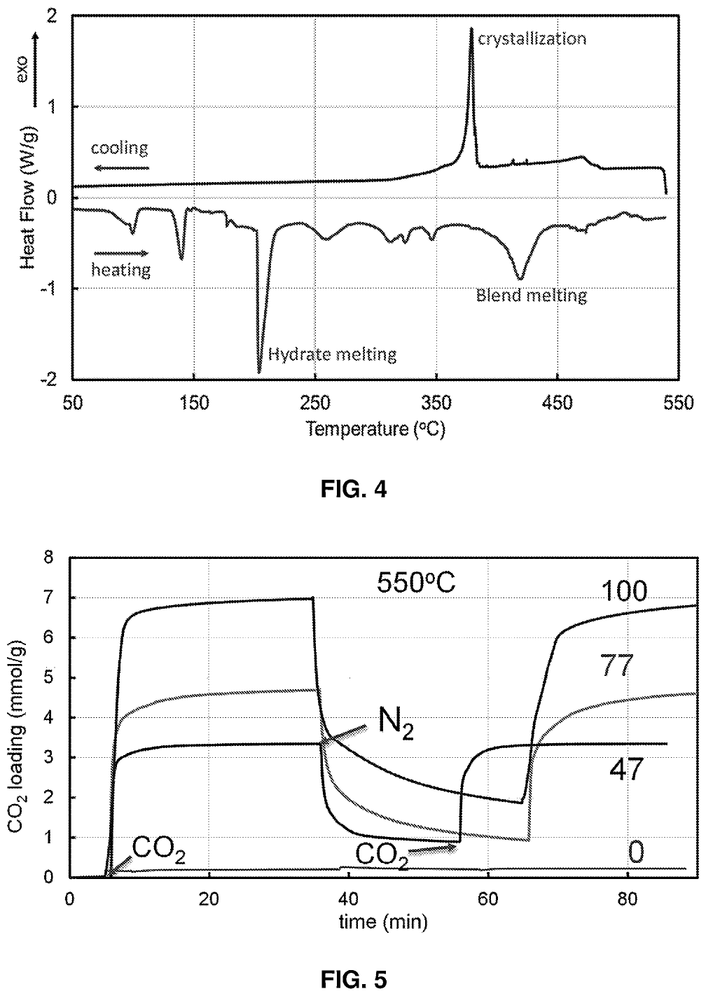

FIG. 4 shows DSC heating and cooling thermograms of the borate/carbonate blend (nominal borate/carbonate ratio, 1:1, Sample No. 3 in Table 1) at 10 deg/min. The blend, as prepared, contained hydrate water and melted above 450° C. The blend recrystallized on cooling at temperatures below 400° C.

### Example 5—Carbon Dioxide Capture by Preferred Borate/Carbonate Compositions

CO₂ capture and uptake by molten borate/carbonate compositions was tested using thermogravimetric analysis (TGA model Q50 by TA Instruments, Inc.) as shown in FIG. 5. Weighed amounts of the compositions, in platinum pans, were first equilibrated for 60 min at 550° C. in nitrogen atmosphere, and then the gas flow was switched from nitrogen to 100% CO₂. The molten compositions containing borate rapidly captured CO₂, so that the weight of the material increased. The maximum sorption capacity for CO₂ was measured, and then the gas flow was again switched from CO₂ to N₂, which caused the CO₂ desorption. The process of the N₂/CO₂ switching was repeated several times, demonstrating the reversibility of the CO₂ sorption by borates. Sorption of CO₂ by the carbonate composition without the borate at 550° C. was low (˜0.2 mmol/g) and lacked reversibility, whereas the sorption capacity of 100% borate was high (over 7.1 mmol/g) and fully reversible. Sorption capacity of the borate/carbonate blends increased with the borate content. These experiments showed that the higher borate concentrations in their blends with carbonates are advantageous for maximizing the CO₂ capture.

### Example 6—Electrolysis of CO₂ in Borate/Carbonate Blend Electrolyte

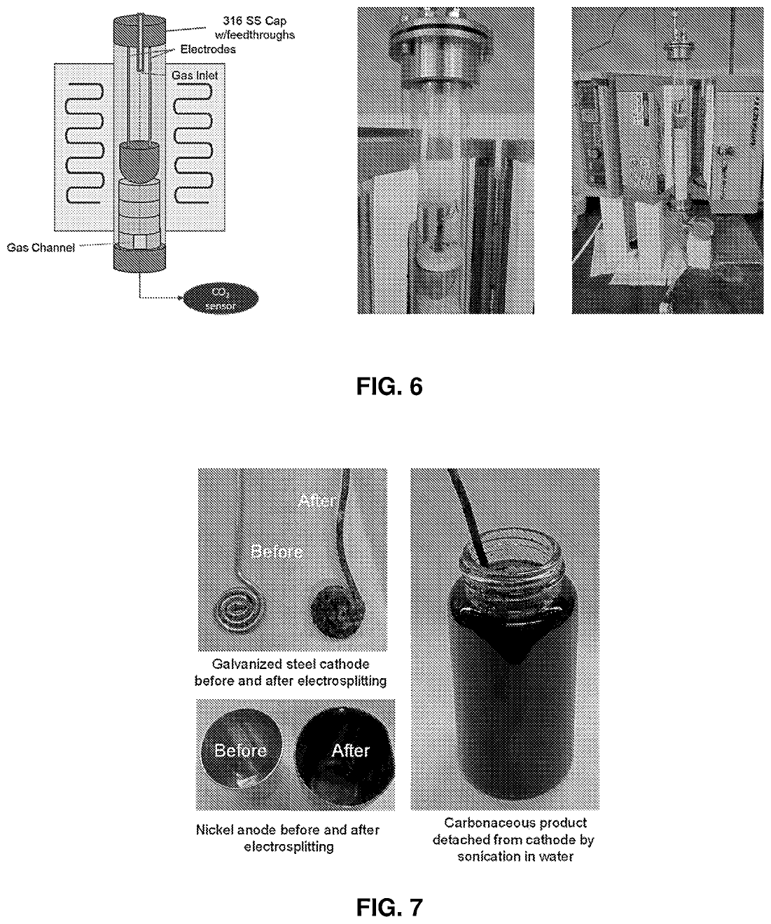

Electrolysis of CO₂ was conducted using a temperature-controlled tubular glass reactor equipped with furnace, gas inlet/outlet, stainless steel caps, and insulated electrode lines depicted in FIG. 6. The electrode cables were connected to a computer-controlled BioLogic Model SP-101 potentiostat (Biologic, Seyssinet-Pariset, France).

The anode comprised a nickel crucible composed of 99.5% nickel (nominal volume, 20 mL, Sigma-Aldrich Chemical Co.). The cathode was composed of hot-dip galvanized steel wire (Fi-Shock WC-14200, G90 coating designation according to ASTM A653; zinc coating layer thickness approximately 18 μm). The cathode was fabricated from a 14 Ga wire made into a disk with area of ca. 2 cm². The anode (crucible) was filled with ca. 22 g of the salt at ambient temperature, the cathode was inserted, and the salt was molten at 550° C. for equilibration. The cell was transferred to the tubular reactor, sealed and re-equilibrated at given temperature in the 550-600° C. range while purging by nitrogen flow for 40 min. The current density on cathode during the electrolysis was 120 mA/cm². Gas flow through the reactor was ca. 50 mL/min. Cyclic voltammetry measurement between cathode and anode was conducted, then the gas was switched from nitrogen to pure CO₂, and the reactor was kept under CO₂ atmosphere for 3.5-4 h; a cyclic voltammetry measurement was then repeated, and the electrolysis commenced. Constant current of 240 mA between cathode and anode was applied for 1 h during electrolysis, while maintaining the reactor at a given temperature. Following electrolysis, the cathode was withdrawn from the reactor at the given temperature and the reactor was allowed to equilibrate at ambient temperature.

As the result of the reactions, the withdrawn cathode was observed to be black, with carbonaceous products of the electrolysis adhering to the cathode surface; the nickel anode was observed to be covered by a black coating due to the formation of nickel oxide (FIG. 7). The withdrawn cathode was then placed into deionized water and sonicated for 30 min, producing black suspension (FIG. 7). The suspended particles were separated by centrifugation, resuspended with sonication in 1 wt % aqueous HNO₃ solution, and dialyzed for 2-7 days at room temperature against excess 1 wt % aqueous HNO₃ solution (membrane MWCO, 12-14 kDa). Thus obtained purified electrolysis products were dried under vacuum, weighed and characterized by elemental analysis, powder X-ray diffraction (XRD), and scanning and transmission electron microscopy (SEM and TEM).

### Example 7—Electrochemical Reactions Occurring During CO₂ Electrolysis in Borate/Carbonate Compositions

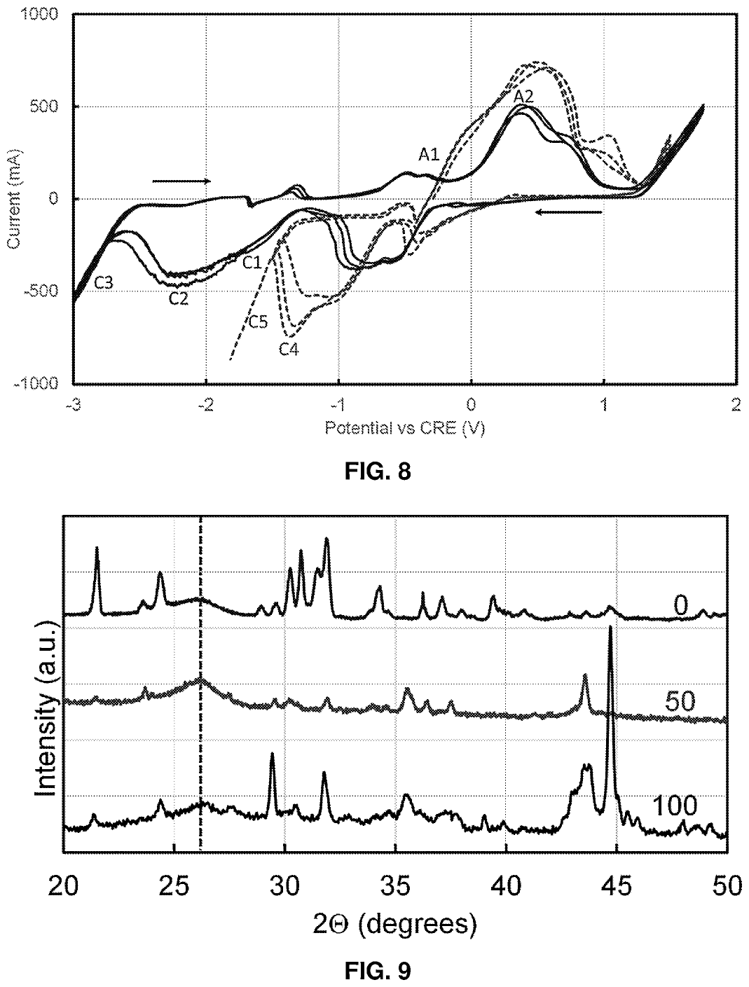

Electrochemical reactions generally occur in molten mixed borate/carbonate electrolyte during CO₂ electrolysis (FIG. 8).

In FIG. 8, CRE stands for Carbonate Reference Electrode (standard potential vs reference CO₂ oxidation reaction is E^{o}=0 V). In our control experiment conducted under air purge, a systemic −0.131 V shift was observed due to the electrochemical cell parameters and conditions relative to the standard potential (E₉₀₀^{o}=0 V) characteristic of the carbonate ion oxidation in molten carbonates:

CO₃²⁻→CO₂+0.5O₂+2e⁻ (10)

Reaction 10 is indicated by A1 in FIG. 8. The observed formation of black coating on the anode interior (compare with FIG. 7) is attributed to the nickel oxidation reaction on the anode-melt interface with the reported standard potential E₉₀₀^{o}=0.697 V.

NiO+CO₃²⁻→NiO+CO₂+2e⁻ (11)

Reaction (11) is indicated by A2 on the oxidation scan in nitrogen atmosphere in FIG. 8. Lower oxidation currents are observed on the initial scan. Numerous prior studies reported a variety of reduction reactions for nickel compounds in the presence of neutral gas or carbon dioxide:

NiO+2e⁻→Ni^{o}+O₂⁻;E^{o}=−1.50V (12)

During the cathodic reduction, at potentials in the −1.2 to −0.7 V range nickel oxide dissolves, forming complexes of nickel and carbonate ions. These complexes are reduced to nickel and carbonate ions; the formed nickel is then oxidized in the following anodic scan, at potentials in the 0.7 to 1.2 V range.

For the purposes of the present disclosure, electrochemical processes occurring with nickel and nickel oxide can be considered side reactions, whereas the reactions of electrodeposition of carbon by CO₂ electrolysis are target product reactions, which will be reported next.

Important deposition potentials of alkali and alkaline earth metals via reactions (13) and carbon through reactions (14) in their own molten carbonate salts are known and are given below in Table 2.

### Electrochemical Deposition of Metal:

2M₂CO₃→4M+2CO₂+O₂(M=Li,Na or K) (13)

### Deposition of Carbon Via Carbonate Salt Decomposition:

3M₂CO₃→C+3M₂O+2CO₂+O₂ (14)

TABLE 2
Deposition potentials (vs. CO₃²-/CO₂-O₂) of alkali and alkaline earth metals via
reaction (13), and carbon via reaction (14) in their respective molten carbonate salts at
600° C.. Deposition potentials are taken from Ijije et al. (H. V. Ijije, R. C. Lawrence, N.
J. Siambun, S. M. Jeong, D. A. Jewell, D. Hu, and G. Z. Chen, “Electro-deposition and
re-oxidation of carbon in carbonate-containing molten salts,” Faraday Discuss., 2014,
172, 105-116.), which is incorporated herein by reference in its entirety.

| | Alkali metal deposition, | Carbon deposition, |
|---|---|---|
| Molten salt | potential (V) | potential (V) |
| Li₂CO₃ | −2.964 | −1.719 |
| Na₂CO₃ | −2.546 | −2.551 |
| K₂CO₃ | −2.612 | −3.083 |

In our experiments with borate/carbonate blends in nitrogen atmosphere (FIG. 8), carbon was produced by cathodic reduction of the carbonate anions (reaction eq (6)) formed by dissociation of the molten alkali metal carbonates (indicated as C2 in the −2.3 V range). Carbon was deposited on galvanized steel cathode in significant quantities, along with deposition of alkali metals and boron. The processes of deposition are indicated by C3 in FIG. 8.

In the presence of the Li,Na borate in the borate/carbonate blend (FIG. 8), borate anions (BO₃³⁻) formed by dissociation of the borate in the molten salt contribute greatly to the CO₂ capture and its enhanced chemisorption (compare with FIG. 5):

BO₃³⁻+CO₂↔CO₃²⁻+BO₂⁻ (15)

Borate anions also contribute to the metaborate and oxygen anion generation by the molten salt:

BO₃³⁻↔BO₂⁻+O²⁻ (16)

Hence, in the presence of the Li,Na borate, the formation of carbonate anions needed for CO₂ electroreduction is augmented, which in turn leads to the carbon deposition on the cathode at lower cathodic potentials:

CO₃²⁻+4e⁻+3BO₂⁻→C+2BO₃³⁻ (17)

Potentials corresponding to the carbonate electroreduction under CO₂ atmosphere in the −1.4 to −1.2 V range and carbon/metal deposition in the −1.8 to −1.5 V range are indicated by C4 and C5, respectively, in FIG. 8. Electroreduction processes in eq (16) (C4) can be seen as transient, as their peak potentials were lowered with the number of scans, indicating that the majority of the dissolved CO₂ was electroreduced. The electrodeposition of carbon, particularly in the form of CNT, in a molten salt initially consisting of pure Li, Na borate or wherein such borate comprised more than 10 wt % of the total molten salt composition has not been described in the prior art and is serendipitously discovered herein.

### Example 8—Structure of the Products of CO₂ Electrolysis

XRD patterns were obtained by using a 3rd generation Empyrean multipurpose X-ray diffractometer (Malvern PANalytical) equipped with a Cu radiation source and X-ray generator power of 4 kW (max 60 kV, 100 mA) at room temperature. Studied interval was 2θ=4 to 70° and angular resolution, 0.026°.

FIG. 9 shows a general view of the powder X-ray diffraction pattern of the products of CO₂ electrolysis collected on galvanized steel cathodes. Broad peaks centered at 2θ=26-26.2° observed in XRD patterns of the electrolysis products obtained with either molten Li,Na borate or Li,K borate or their blends were prominent. Elemental analysis for carbon content in the products significantly varied from approximately 20 to 98 wt % and depended on the extent of the product purification by washing procedures; concentrations of lithium, zinc and nickel varied in the 0.2 to 3.5 wt %. 0.01-2 wt %, and 0.1-1.5 wt %, respectively. The (100) crystal peaks are characteristic of the multiwall carbon nanotubes and correspond to a d-spacing between graphene sheets (CNT wall layers) of 3.42-3.46 Å. The XRD patterns of the electrolysis products also featured peaks at 2θ=21.3, 30.6, and 31.8°, characteristic of the lithium carbonate admixtures that were not removed from the products in the process of purification, XRD pattern peaks at 34.4 and 2θ=34.4 and 36.2° were due to the presence of ZnO nanoparticles (see standard JCPDS cards #79-0206, #36-1451), formed via oxidation of zinc originally present on the galvanized steel cathode surface. Finally, peaks that are present in some products at 2θ=43.5 and 44.7° are due to NiO crystal lattice (see standard JCPDS cards #78-0423) and Ni electrodeposited onto the product on cathode from the molten salt solution, respectively. It has been noted previously that zinc and nickel ion admixtures to the molten carbonates mediate the synthesis and contribute to the yield of carbon nanotubes in the process of CO₂ electrolysis.

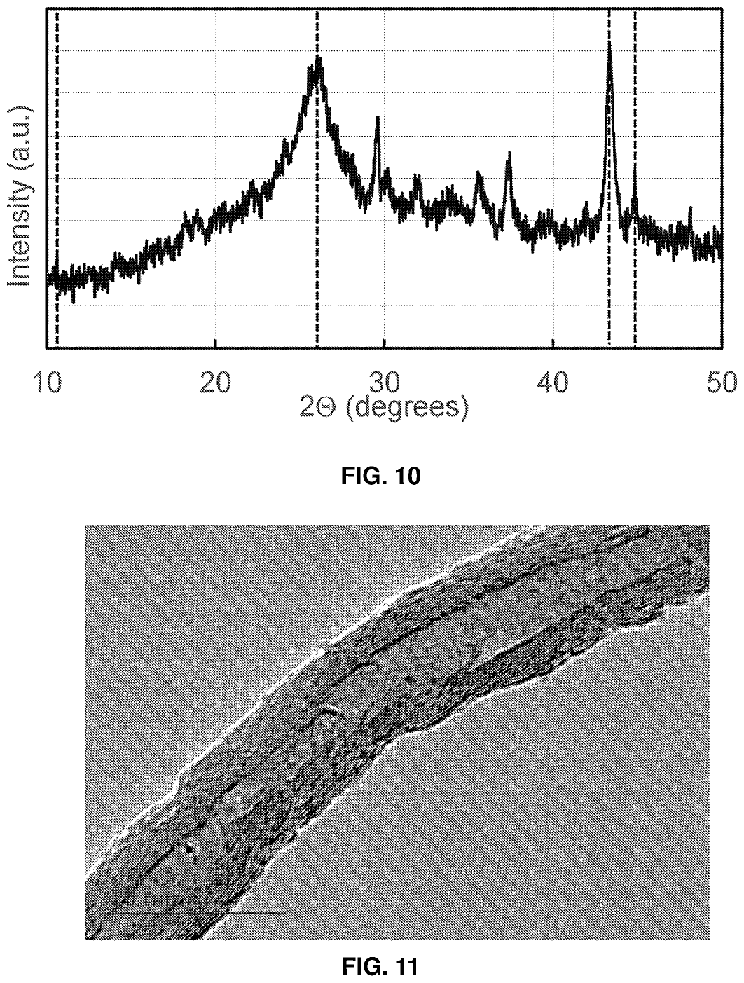

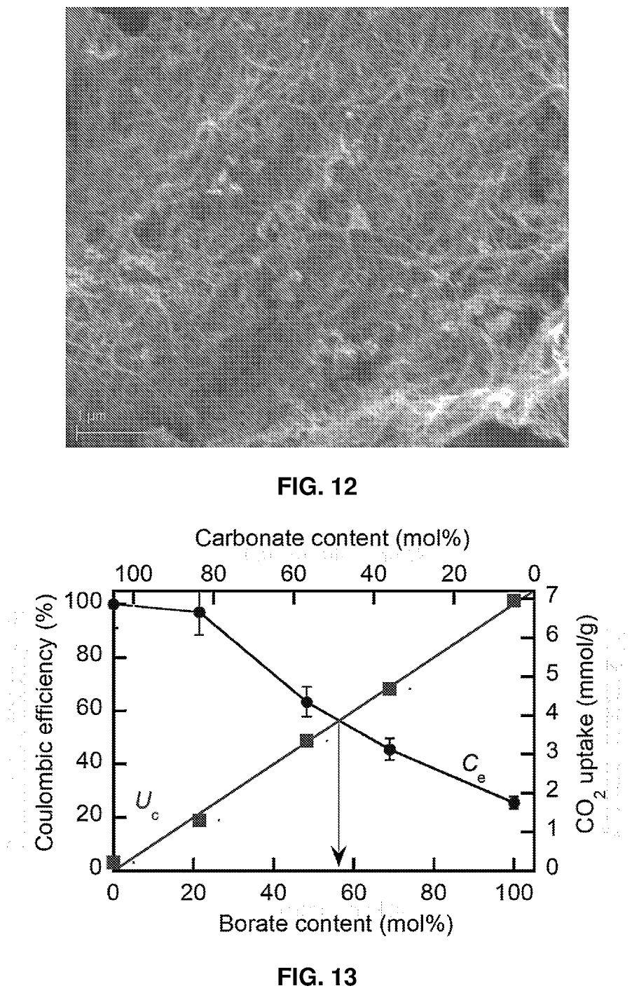

XRD pattern that depicts the CNT structure in more detail is shown in FIG. 10. Peaks seen at 2θ=10.6, 26.2, 43, and 44.3 degrees correspond to a d spacing of 8.5 Å, d-spacing between graphene sheets of ca. 3.4 Å, to the in-plane graphitic structure, and to a lateral correlation between graphite layers, respectively. Overall, XRD patterns unequivocally confirm the CNT structure of the carbonaceous products of the CO₂ electrolysis conducted in the molten borate or carbonate salts of the preferred compositions.

### Example 9

The products of CO₂ electrolysis conducted in preferred compositions were further visualized by means of electron microscopy. Transmission Electron Microscopy (TEM) and Scanning Electron Microscopy (SEM) experiments were conducted using a JEOL 2010 Advanced High Performance TEM and JEOL 5910 General Purpose SEM, respectively. Carbonaceous samples for TEM were deposited onto PELCO® grids from their suspensions in isopropyl alcohol followed by drying under vacuum, whereas SEM samples were deposited dry onto carbon tape. A representative TEM image is presented in FIG. 11.

### Example 10—Preferred Molten Salt Compositions for Capture and Electrochemical Conversion of CO₂ into Carbon

Variation of the molten salt compositions was performed in a dedicated series of experiments, wherein the molten salt composition was varied as described in Example 3 (Table 1). Preferred borate composed of (Li_{0.5}Na_{0.5})ₓB₁₋ₓO_{1.5-x}; x=0.75 and preferred carbonate Li_{0.62}K_{0.38}CO₃ were used at varying ratios. The products were obtained by conducting CO₂ electrolysis in a given molten salt composition at 550° C. as described in Example 6.

Two criteria were used for the composition performance variation: 1. Maximum equilibrium CO₂ sorption (capture) uptake (U_{c}, mmol/g), and 2. Maximum yield of carbonaceous product during CO₂ electrolysis as measured by Coulombic efficiency; both parameters measured at fixed T=550° C.

Coulombic efficiency (Cₑ, %) was calculated as the percent of applied, constant current charge that was converted to carbon during the CO₂ electrolysis, determined as:

$${C}_{e} ( \% ) = 100 \times {M}_{experimental} / {M}_{theoretical} \qquad ( 18 )$$

where Mₑₓₚₑᵣᵢₘₑₙₜₐₗ is the mass of purified carbon product removed from the cathode; M_{theoretical}=(Q/nF)×(12.01 g C mol⁻¹) is the theoretical mass, which is determined from Q, the time integrated charge passed during the electrolysis; F=96.485 A s mol⁻¹e⁻ is the Faraday constant, and n=4e mol⁻¹ is the reduction number of tetravalent carbon. The mass of carbon product Mₑₓₚₑᵣᵢₘₑₙₜₐₗ was determined from the total mass of purified dried product multiplied by the mass fraction of total carbon in that given product sample measured by elemental analysis in a commercial laboratory (EPA 440.0). Standard error for Ce was measured to be 9% in a series of independent experiments.

The effect of the molten salt blend composition on the Coulombic efficiency of the CO₂ electrolysis and the CO₂ uptake at 550° C. is shown in FIG. 13. As is seen, the yield of carbon, and hence, the Coulombic efficiency of the CO₂ electrolysis was higher in carbonate (Cₑ, 100%) than in borate (Cₑ, 20%), the Cₑ parameter declined with the borate concentration in the blend. On the other hand, the CO₂ capture (U_{c}) was linearly proportional to and increased with the borate concentration. The best composition that yielded maximum U_{c} and simultaneously, maximum Cₑ, is at 55-60 mol % borate content. Therefore, the results in FIG. 13 yield preferred borate/carbonate compositions possessing a unique property of being efficient media for the CO₂ electrolysis and simultaneously, efficient reversible molten salt sorbents.

### Example 11—Study of Mixed Alkali Metal Borate and Alkali Metal Carbonates

The following example describes the electrolysis of CO₂ in a borate/carbonate blend, in addition to the characterization of several compositions comprising an alkali metal borate and an alkali metal carbonate.

### Electrolysis of CO₂ in Borate/Carbonate Blend Electrolyte

Electrolysis of CO₂ was conducted using a home-made temperature-controlled tubular glass reactor equipped with furnace, gas inlet/outlet, stainless steel caps, and insulated electrode lines (S-1). The electrode cables were connected to a computer-controlled BioLogic Model SP-101 potentiostat (Biologic, Seyssinet-Pariset, France).

The anode was a nickel crucible composed of 99.5% nickel (nominal volume, 20 mL, Sigma-Aldrich Chemical Co.). A copper coil with a copper wire lead was used as an electrical connector.

The cathode was constructed of hot-dip galvanized steel wire (Fi-Shock WC-14200, G90 coating designation according to ASTM A653; zinc coating layer thickness approximately 18 μm). The cathode was fabricated from a 14 Ga wire made into a disk with area of ca. 2 cm². Identical cathodes but made of 316SS stainless steel wire (McMaster-Carr), or 99% nickel rod (Goodfellow), were used in separate series of experiments.

The electrolysis experiments detailed in this example comprised of the following steps:
i) The salt powder was loaded into a nickel crucible and placed into the furnace. After purging with N₂ flow for 30 min, the furnace was then heated to the designated temperature (550 or 600° C.) within 75 min and held isothermally for 60 min to melt the salt and release residual water.
ii) After cooling, freezing, and disassembly, a hole was drilled in the solidified salt and used to insert the cathode, which was then locked into place by a mica lid with holes for gas exchange. This ensured full submersion of the cathode regardless of variations in packing density of the initial salt powder;
iii) After assembly, the electrolysis cell was loaded into the tube, and N₂ was purged for another 30 min at room temperature. The furnace was then heated to 550° C. or 600° C. in 75 min and held isothermally for 60 min to ensure full melting before cyclic voltammetry measurements were taken;
iv) The gas flow was then switched to 50 cc/min of 100% CO₂ and held isothermally for 3 h before additional cyclic voltammetry measurements were taken. The electrolysis process was conducted in the galvanostatic mode with a constant current of −240 mA applied for 1 h, and the cathode was manually lifted out of the salt prior to cooling and freezing; and
v) The carbonaceous product and residual salt were removed from the cathode by sonication in deionized water (0.5 h). The product was then purified from the residual salt by 3 to 4-day dialysis of the suspension against excess of aqueous 1% nitric acid (membrane cut-off, 12-14 kDa) followed by the particle removal, washing in deionized water, and lyophilization.
   Coulombic efficiency (Ce, %) was calculated as the percent of applied, constant current charge that was converted to carbon during the CO₂ electrolysis, determined as: 6 Ce (%)=100×Mₑₓₚ/Mₜₕₑₒᵣ (10) where Mₑₓₚ is the mass of purified carbon product removed from the cathode; Mₜₕₑₒᵣ=(Q/nF)×(12.01 g C mol⁻¹) is the theoretical mass, which is determined from Q, the time integrated charge passed during the electrolysis; F=96,485 A s mol⁻¹e− is the Faraday constant, and n=4e− mol⁻¹ is the reduction number of tetravalent carbon atoms. The mass of carbon product Mₑₓₚ was determined from the total mass of purified dried product multiplied by the mass fraction of total carbon in that given product sample measured by elemental analysis. Standard error for C, was measured to be 9% in a series of independent experiments.

### Results and Discussion

### Characterization of the Molten Salt Properties

The choice of the eutectic carbonate (Li_{1.24}K_{0.76}CO₃) described in this example was predicated on the prior studies demonstrating relatively low melting temperature and concomitant lithium content of that particular carbonate. High Li content can be conducive to the enhancement of carbon yield during electrolysis. On the other hand, the Li, Na borate utilized throughout (Li_{0.5}Na_{1.5}BO₃) was chosen due to the extensive work by indicating that this particular composition possessed desired CO₂ sorption capacity relative to others while maintaining liquid properties and homogeneity even after reaction with CO₂ in the molten state.

Thermal Properties of Alkali Metal Borates and their Blends with Carbonates

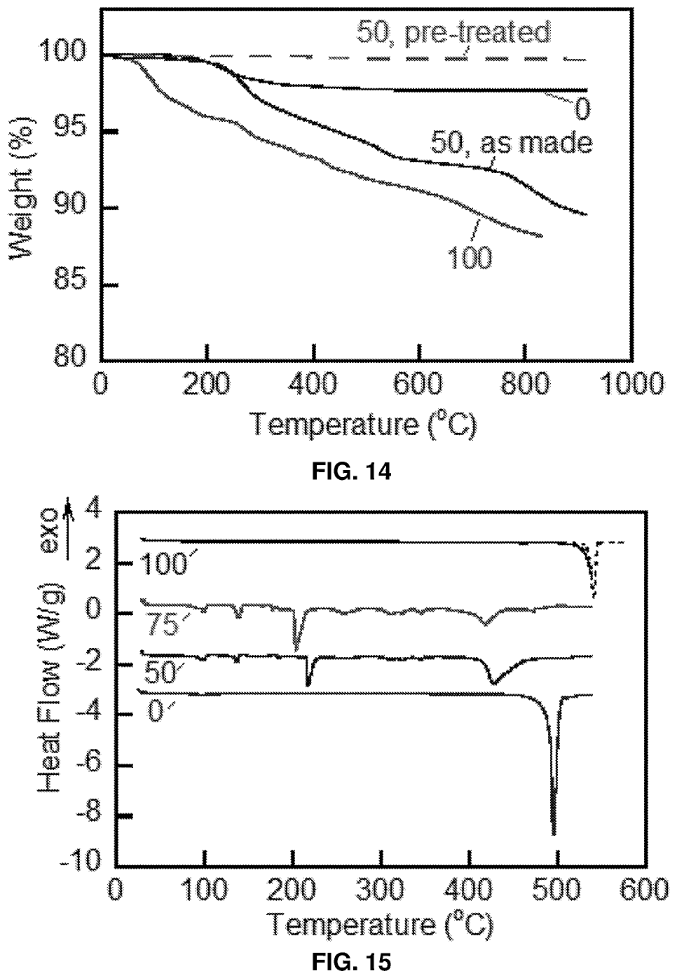

Representative TGA and endothermal DSC thermograms on heating of samples of the studied alkali metal borate and carbonate, and their blends in a nitrogen atmosphere are shown in FIG. 14 and FIG. 15, respectively. The lithium-containing samples contained varying fractions of crystalline water. Li, K carbonate lost the majority of that water at T>130° C. and showed stability until approximately 700° C., above which the weight loss began due to decomposition. Eutectic Li, K carbonate (Li_{1.24}K_{0.76}CO₃) showed no further weight loss during repeated TGA cycling in the range up to 650-700° C. (data not shown). In comparison, Li, Na Borate (Li_{1.5}Na_{1.5}BO₃) appeared to be more hygroscopic than the carbonate and lost crystalline water over several stages, above 100, 230, and 400° C. In the repeated cooling and heating cycles, the borate showed no signs of weight loss at temperatures up to 900° C. The borate-carbonate blend pre-treated at 600° C. in nitrogen atmosphere lost less than 1% of its weight over a broad range of temperatures (FIG. 14). Hence, the prepared blends showed promise as stable regenerable molten media for repeated temperature cycling operations.

DSC traces showed (FIG. 15) that the studied salt compositions melted at temperatures below 550° C., demonstrating sharp melting endotherms. Melting of the eutectic carbonate Li_{1.24}K_{0.76}CO₃ was centered at 496° C., in excellent agreement with previously reported data. Borate Na_{1.5}Li_{1.5}BO₃ melting occurred at 539° C. The borate-carbonate blends (B/C molar ratios 1:1 and 3:1), as prepared, contained residual hydrate water and melted above 450° C. The blends recrystallized on cooling at temperatures below 400° C. (cooling exotherms are not shown in FIG. 15). Melting in nitrogen atmosphere enabled removal of crystalline water. Importantly, the materials studied were observed to be consistently liquid at 550° C. under nitrogen atmosphere or in air.

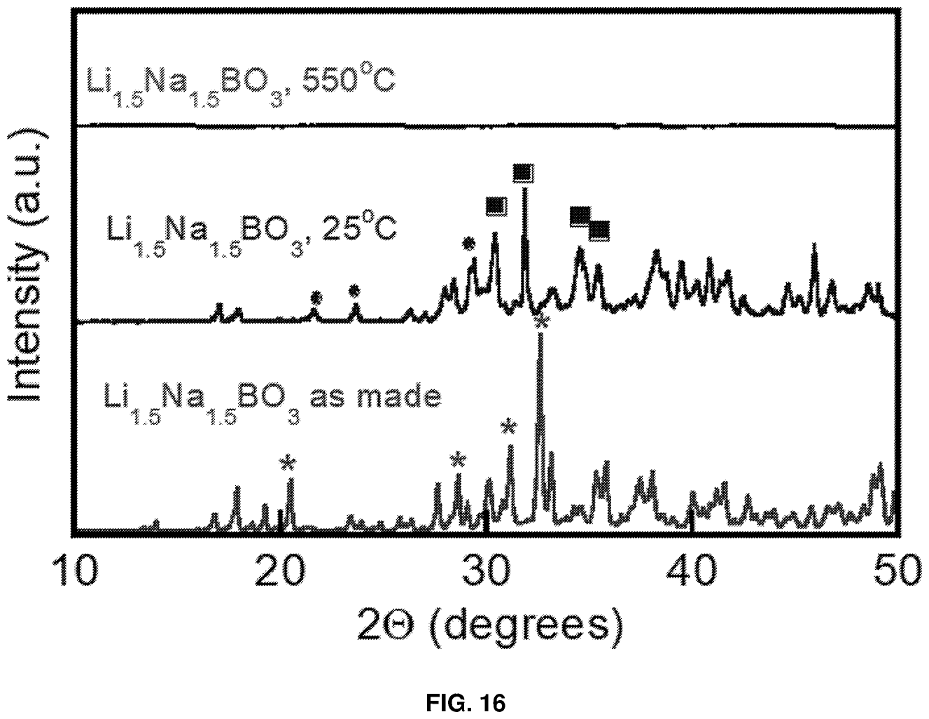

However, due to the reactivity of the borate with CO₂ and its chemical conversion to metaborate while generating alkali metal carbonate, formation of multiple metastable phases upon reaction of the borate component with CO₂ was possible. Thus, the samples were examined for the formation of crystalline phases, if any, in the borate/carbonate blend upon its uptake of and reaction with CO₂ in cooling and subsequent re-melting of the reacted blend (FIG. 16). The reaction was conducted on a platinum pan in 100% CO₂ at 550° C. for 3 h and then the reacted blend sample was cooled at 5° C./min to ambient temperature in a CO₂ atmosphere and the recrystallized material was placed on a zero-background silicon wafer, where XRD was measured at 25° C. (b) and 550° C., also in a CO₂ atmosphere (c). It was observed that upon reaction of the borate component with CO₂, the reacted blend re-melted and demonstrated the absence of any crystalline phases at 550° C. (FIG. 16). This is important for the heating-cooling cycling (temperature swing operation) of the blends in their utilization as regenerable CO₂ sorbents.

### Viscosity of Alkali Metal Borate/Carbonate Blends

Alkali (e.g., Li) meta- and tetraborates have been used extensively in a number of applications, primarily as fluxing components for X-ray fluorescence (XRF), atomic emission spectrometry and related analytical techniques. Molten lithium tetraborate generally possesses a high viscosity and tends to solidify as a glass under small temperature gradients. The viscosity of molten lithium borates under temperature gradients is determined by the ratio of optically opaque crystalline matrices and amorphous phases, both with the chemical formula of Li₂B₅O₉. The amorphous motif can have the structural form of a single tetrahedral boron connected to four oxygen atoms. The oxygen atoms are connected to the trigonal boron species to form a ring with the chemical formula of B₃O₃. In contrast to the alkali metal borates, alkali metal carbonate melts are extremely fluid and the viscosity of the Na₂CO₃, K₂CO₃, and Li₂CO₃ liquids measured by rotational viscometers is on the order of 3-20 mPa in the 750-1000° C. range and demonstrates Arrhenian behavior.

In this example, the behavior of blends of the two distinct classes of alkali metal salts, i.e., borates and carbonates, were studied in their molten state under moderate shear stresses and in the lowest temperature range (550-600° C.), wherein both salts are molten. No reports on the viscosity of blended borate-carbonate melts were available, albeit the viscosities of individual NaₓB₁₋ₓO_{y} (x=0.75) and (Li_{0.5}Na_{0.5})ₓB₁₋ₓO_{y} (x=0.75) borates in the molten state at 600° C. have been reported previously by us.

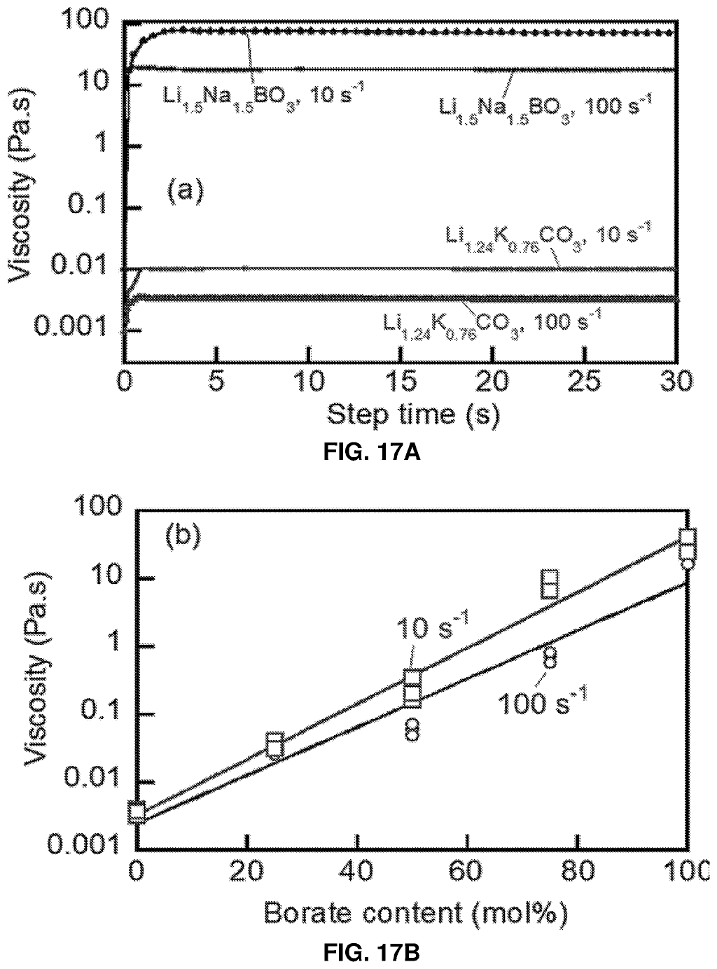

FIG. 17A shows representative rotational viscosity measurements of the Li, Na borate (Li_{1.5}Na_{1.5}BO₃) and eutectic Li, K carbonate (Li_{1.24}K_{0.76}CO₃) at 550° C. at constant shear rates of 10 and 100 s⁻¹. Pronounced shear-thinning behavior of both molten salts was evident in these measurements, with the borate's viscosity being 3 orders of magnitude larger than that of the carbonate at that temperature. The viscosity of Li_{1.5}Na_{1.5}BO₃ measured at constant 100 s⁻¹ and 550 and 600° C. was 32±8 (n=3) and 14±5 Pa·s (n=3), respectively, which corresponded well with the previously reported data on Li, Na borate at 600° C.

Variation of the borate content in the blends (FIG. 17B) appeared to produce a pronounced effect on the blend viscosity, ranging over 3 orders of magnitude. The results show that eutectic carbonates act as an efficient diluent for the molten alkali metal borates and the blend's viscosity can be adjusted as required for proper handling, pumping, circulation, and other operations requiring transport of molten salts at high temperatures, especially in heat transfer and electrolysis applications. CO₂ uptake by alkali metal borates and their blends with carbonates

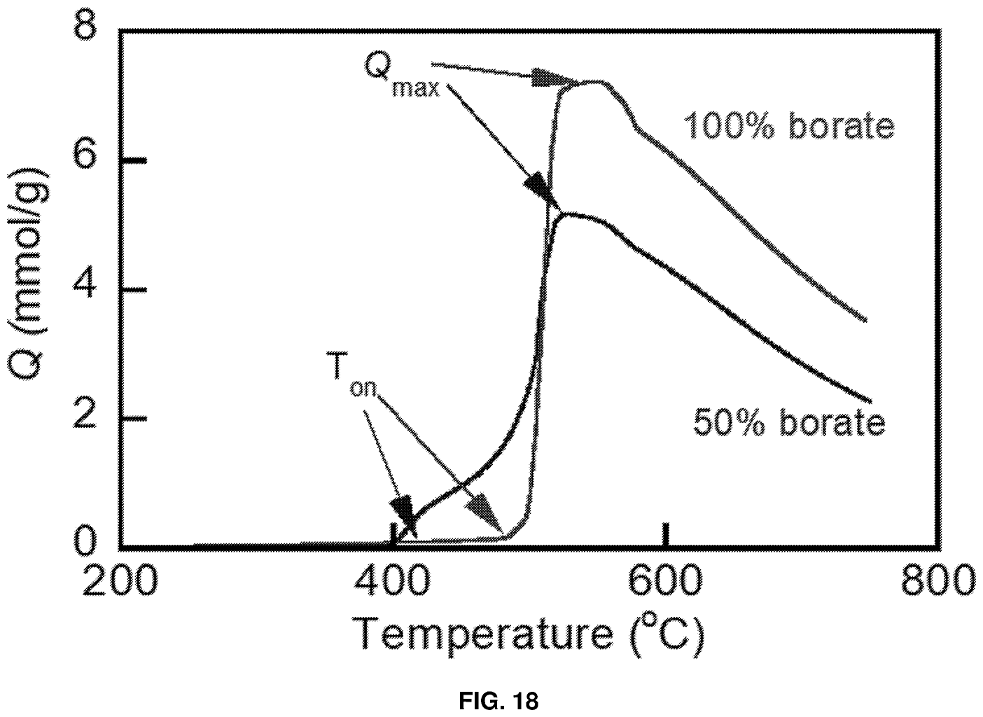

The parameters of CO₂ uptake by molten salts were examined with Li, Na borate, Li_{1.5}Na_{1.5}BO₃ and its representative blend with the eutectic Li, K carbonate under study, Li_{1.24}K_{0.76}CO₃ (FIG. 18). The uptake of CO₂ (Q, mmol/g) during temperature was ramped at a very slow rate of 0.33° C./min under a flow of 100% CO₂. Prior to the temperature ramp in CO₂, the samples were first purged of water and adsorbed air by exposing them to the N₂ flow and ramping the temperature to 600° C. at 5° C./min and then allowing to equilibrate, also under N₂ flow, at 200° C. for 1 h. The slow heating rate enabled precise determination of temperature of the CO₂ uptake onset (Tₒₙ) and the CO₂ uptake maximum (Qₘₐₓ).

The uptake of CO₂ by Li, Na borate increased dramatically once the temperature was raised to the onset temperature (Tₒₙ) of 492° C. After the sharp increase of the CO₂ uptake at Tₒₙ, the uptake rapidly reached maximum load capacity (Qₘₐₓ, ˜7.1 mmol/g) at Tₘₐₓ=552° C. and then after a short plateau started to decrease at higher temperatures starting at 563° C. Similar behavior was observed with the borate-carbonate blend. However, the presence of Li_{1.24}K_{0.76}CO₃ carbonate in the blend caused a dramatic temperature shift in Tₒₙ to 395° C., and the uptake became two-step, increasing first at >395° C. and then more significantly around 460° C. before a final rapid increase, plateau and subsequent decrease. The shift of the Tₒₙ values in the presence of carbonate in the blend is certainly due the existence of the Li, K carbonate crystals left in the blend after melting and recrystallization that preceded the CO₂ uptake. The crystals are molten above 530° C. (compare with FIG. 16). The Li, K carbonate crystals melt at temperatures much lower than those of the individual borate Li_{1.5}Na_{1.5}BO₃ (compare with FIG. 15); the onset of glass transition and melting and the existence of mobile and liquid phases in the salt enables rapid gas-liquid mass exchange and absorption of CO₂ by the melt, which explains the significantly lower Tₒₙ in the blend vs that in pure borate.

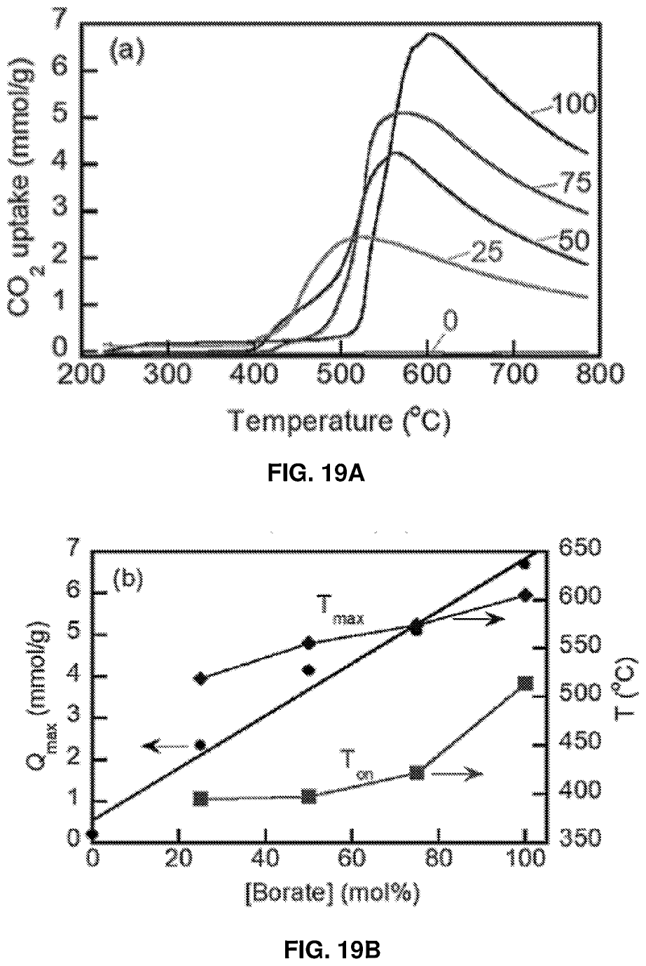

FIG. 19A shows the effect of varying borate/carbonate blend composition on the CO₂ uptake under a flow of 100% CO₂ at a constant heating rate of 5° C./min. The Tₒₙ scaled with the heating rate (not shown).

As is seen in FIG. 19B, the addition of eutectic Li_{1.24}K_{0.76}CO₃ carbonate to Li_{1.5}Na_{1.5}BO₃ borate under study lowered the Qₘₐₓ of the blend because the carbonate's ability to physisorb CO₂ in the studied temperature range is low and does not exceed approximately 0.2 mmol/g. The Qₘₐₓ values increased linearly with the overall borate concentration. However, both Tₒₙ and Tₘₐₓ significantly decreased with the carbonate addition, which indicates that the blends can be operated as reversible absorbents at lower temperatures than pure borates, which is beneficial.

### CO₂ Absorption in Pressure Swing Cycling Operation

It had previously been discovered that molten alkali metal borates act as reversible liquid absorbents for CO₂ capture in the medium temperature range of 550 to 600° C., with regenerability over multiple absorption-desorption cycles under both temperature- and pressure-swing operations. Such behavior of the molten borates in a cyclical absorption-desorption process was ascribed to the “instantaneous” formation of carbonate salts and their subsequent dissociation resulting in carbonate ions being present in the borate without the diffusional transport restrictions imposed by solid product layers characteristic of solid adsorbents.

In the context of the present disclosure, it was set out to (i) ascertain whether such cycling would be possible with the borate/carbonate blends, and moreover, (ii) establish whether the carbonate salt added to the borate salt prior to any CO₂ chemisorption, would change the kinetics of the

### CO₂ Upload and Desorption

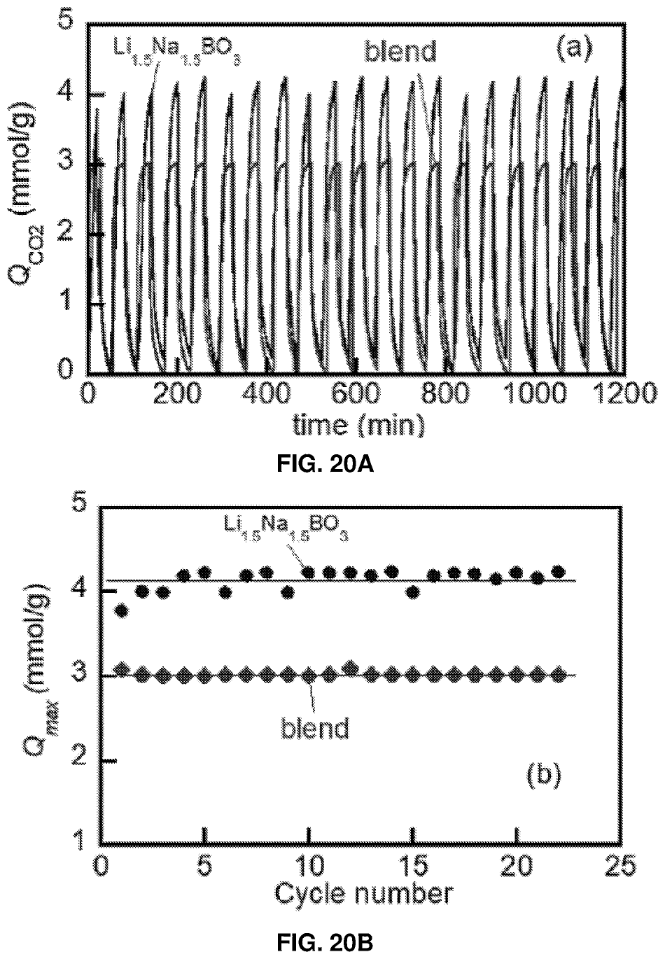

For the direct comparison, a Li, Na borate (Li_{1.5}Na_{1.5}BO₃) and eutectic Li,K carbonate (Li_{1.24}K_{0.76}CO₃) blend (borate/carbonate ratio, 1:1 mol/mol) were chosen as representative examples. Both the borate and the blend have been shown to be liquid at 550° C. (FIG. 15 and FIG. 16), and hence, the pressure swing cycling was performed at that temperature. The results shown in FIG. 20A demonstrate that both the borate salt alone and its blend with eutectic carbonate exhibited reversible uptake-desorption of CO₂ in the pressure swing operation, within the span of at least 22 cycles. The results were quantified with Qₘₐₓ values defined at the end of each sorption cycle (t=30 min after the instance of the switch to the CO₂ flow) (FIG. 20B). As is seen, after the initial 3-4 cycles, the Qₘₐₓ reached constant values of approximately 4.2 and 3.1 mmol/g for the borate and the blend, respectively. The lower Qₘₐₓ values for the blend vs borate alone are expected (compare with FIG. 19B). Importantly, however, the blend did behave as a reversible liquid sorbent. Encouraged by this observation and armed with the knowledge of the dilution effect of the carbonate on the blends' viscosity (FIGS. 17A-17B), a comparative study of the kinetics of the CO₂ uptake by the borate alone and by the blend in the pressure swing operation were performed.

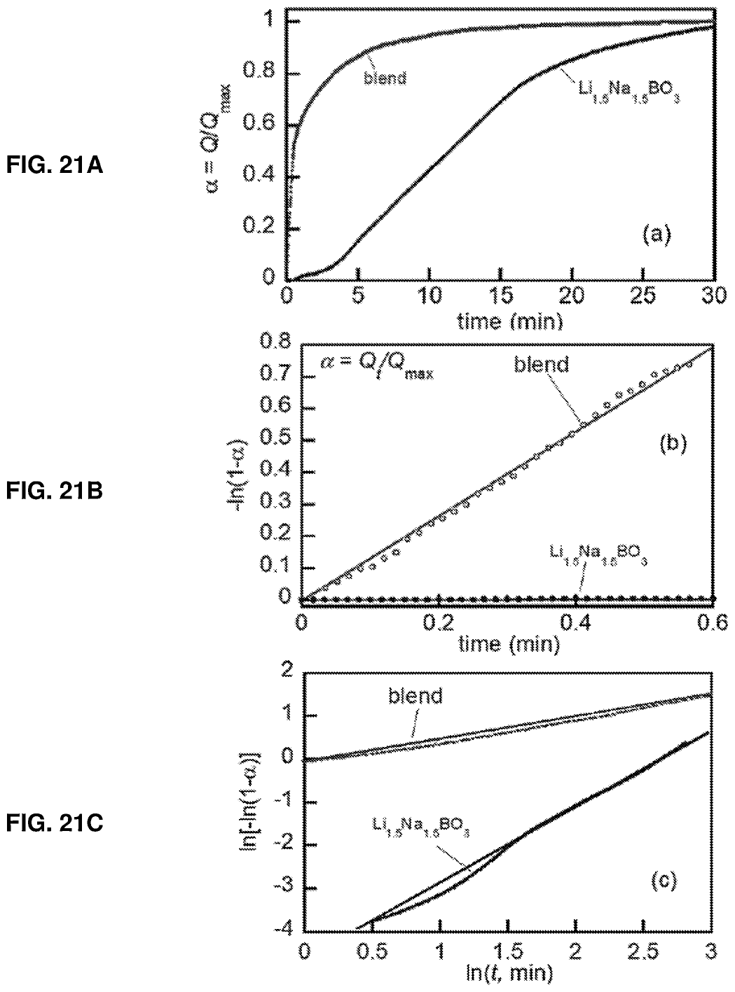

Detailed comparison of typical CO₂ uptake kinetics in one cycle of the cyclical pressure swing operation shows dramatic differences between the pure borate and the blend kinetics (FIG. 21A). Herein, the uptake (Q) is presented via the degree of conversion α=Q/Qₘₐₓ; wherein Qₘₐₓ, mmol/g, is the maximum CO₂ loading in the cycle at t_{cycle}=30 min.

FIG. 21B shows dramatic differences in the kinetics of the CO₂ uptake between pure borate and its blend with carbonate. The blend absorbed CO₂ very rapidly at the very beginning of the cycle, with the high degrees of conversion α>0.6 reached within 1-2 min, whereas with the pure Li, Na borate the initial rate of absorption was low, starting to accelerate at t>0.6 min, which was followed by gradual deceleration of the CO₂ uptake at t>15 min. Analogous results with Li_{1.5}Na_{1.5}BO₃ have been previously obtained at 600° C. The S-shaped uptake kinetics (slow induction rate-acceleration-leveling off period) can be explained by the initial lag time required for dissolution of CO₂ to accumulate carbonate ions (CO₃²⁻) in the viscous molten borate oxides at sufficient levels to exceed the supersaturation threshold for nucleation and growth of crystal nuclei to form solid Li, Na carbonate particles (LiNaCO₃). In the molten borate-carbonate blend, the carbonate ions are present prior to the onset of the CO₂ uptake and hence, the initial uptake reaches high degrees of conversion.

The overall kinetics of the CO₂ uptake by the molten salts with the nucleation and growth of the carbonate crystalline particles, which can eventually form diffusional barriers for further uptake can be qualitatively described by considering the time intervals over which the uptake rate changes separately.

The initial CO₂ uptake can be described by the pseudo first-order reaction kinetics:

$$- d Q d t = {k}_{1} Q , or after integration , - ln ( 1 - α ) = {k}_{1} t , \qquad ( 11 - 1 )$$

where α=Q/Qₘₐₓ.

The kinetics presented in FIG. 21B in terms of eqn (11-1) highlights dramatic differences in the initial uptake rate by the pure borate Li_{1.5}Na_{1.5}BO₃ and its blend with carbonate. The blend started absorbing CO₂ instantly and reached high degrees of conversion (α>0.7) at 0.6 min, whereas pure borate showed an induction lag time before starting to uptake CO₂. The pseudo-first order reaction rate constant in the case of the blend (k1=1.4 min⁻¹) was 250-300-fold higher than that with pure borate (k₁˜5×10⁻³ min⁻¹).

The changes in the CO₂ uptake rate after the initial period (0.6<t<15 min) are described by the well-known Avrami-Erofeev nucleation and nuclei-growth model:

−ln(1−α)=k₂tn; n=p+m (11-2), where m refers to a dimensional number related to the nuclei growth, p is a nucleation occurrence constant, and k₂ is the reaction rate constant.

FIG. 21C shows a logarithmic plot where kinetics of the borate and blend in the 0.6<t<15 min period are presented in terms of eqn (11-2). The rate of the CO₂ uptake increased with the borate and significantly slowed down with the blend, probably due to the nucleation and growth of crystals as a result of CO₂ reaction with the borate component that is faster in pure Li, Na borate than in the blend when the borate was diluted by carbonate. The k₂ estimates from the linear regression fits (FIG. 21C, R²>0.99) for the borate and blend are 1.9 and 0.6, respectively. The linearity of the plots in FIGS. 21A-21C (eqn. (11-1)) indicates that the uptake rate was controlled by a second order reaction, possibly through the coordination of double alkali-metal ions to stabilize the carbonate ions forming in the molten boron oxide, without wishing to be bound by any particular theory.

After approximately 15 min, the CO₂ uptake by both borate and the blend further slowed down, attributed to the approaching saturation of the boron oxide melt by the formed carbonates at longer times, and high conversion degrees (α>0.8) observed in the reversible reactions of the carbonate formation and decomposition.

In summary, it was observed that the Li, Na borate and borate/carbonate blends can be applied as reversible molten absorbents of CO₂, without a significant deterioration in the absorption (capture) capacity over many cycles of the pressure swing operation. Addition of carbonates to the molten carbonate lowers overall CO₂ uptake due to the lower sorption capacity of carbonate at the temperatures studied. However, the addition of eutectic carbonates to the molten Li, Na borate lowers the melt viscosity and enables lowering of the temperature of the pressure swing operation as well as dramatically accelerates the CO₂ uptake during the initial stage of the cycle

### Electroreduction of CO₂ in Molten Alkali Metal Borate/Carbonate Blends

In order to conduct CO₂ electrolysis in molten Li, Na borate/Li, K carbonate blends, the choice of the cathode and anode (surfaces from which electrons flow into and from, respectively) is one important factor. Concurrent experiments indicated that the molten Li, Na borate can be reliably contained within metallic containers while ceramic crucibles were either damaged by the molten borate or cracked at temperatures of 600° C. Metals, and in particular, nickel, have been used previously as anode materials in CO₂ electrolysis in molten alkali metal carbonates. Nickel is readily oxidized in the presence of the molten salt, but the formed nickel oxide layer protects the deeper nickel layers from further oxidation; moreover, nickel oxide is sufficiently conductive that it does not impede the flow of electrons from the anode. Therefore, for this example, nickel crucibles were chosen to serve as anodes. The cathode employed herein consisted of galvanized steel wire. Galvanized steel is an inexpensive material that in the experiments with alkali metal borates, produced carbon in the form of CNTs. The zinc layer alloyed with the steel wire via hot-dip processes plays a significant role in the CO₂ electrolysis in molten alkali metal carbonates.

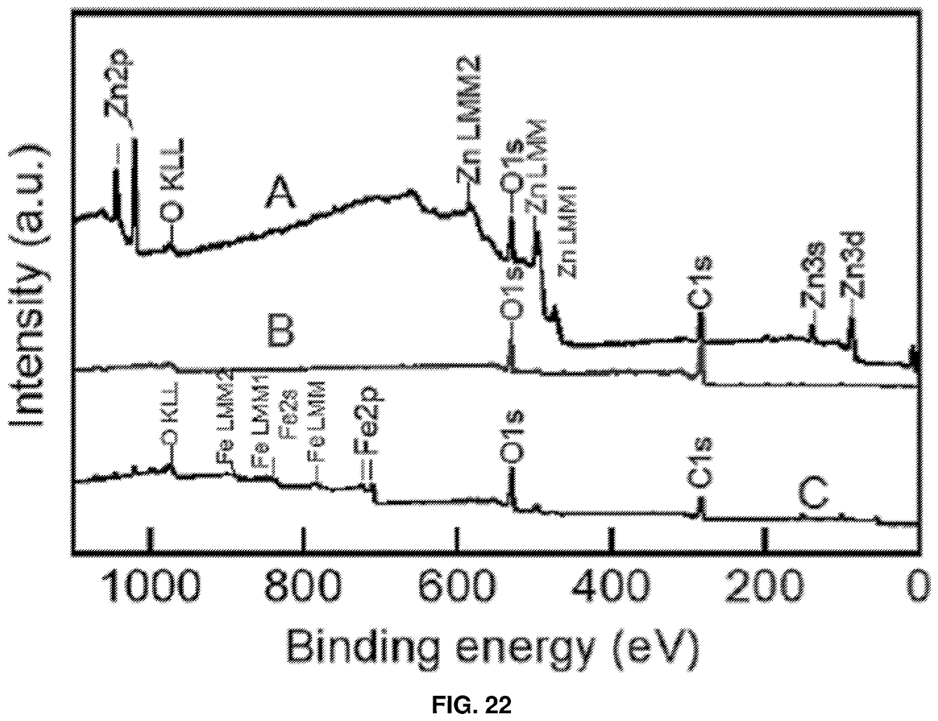

During electrolysis, the cathode was coated by carbon deposits that could be readily removed mechanically by sonication in acidic aqueous solution, resulting in colloidally stable suspensions. The removed material was dialyzed against excess aqueous solution and lyophilized for further characterization (see Experimental of this example, above). The processes occurring on the galvanized steel electrode that underwent various changes during the process of CO₂ electrolysis and then removed from the melt were elucidated using XPS spectroscopy (FIG. 22). Peaks belonging to zinc (Zn_{2p3/2} at 1021 eV, Zn LMM Auger peak centered at 498 eV, etc.) and the Zn—O bond in the ZnO matrix centered at 530 eV 56 (A in FIG. 22) disappeared as the electrode was coated by the carbonaceous material during electrolysis (B in FIG. 22) and when that carbonaceous layer was mechanically removed, peaks belonging to the underlying iron of the bare steel layer (Fe_{2p3/2} at 711 eV of Fe—O and others), appeared (C in FIG. 22). These results clearly show that the zinc coating on the galvanized steel electrode melted at T>420° C. and then dissolved into the molten salt electrolyte, where it co-nucleated with the forming carbon nuclei, accelerating their aggregation, growth and subsequent assembly into carbonaceous material.

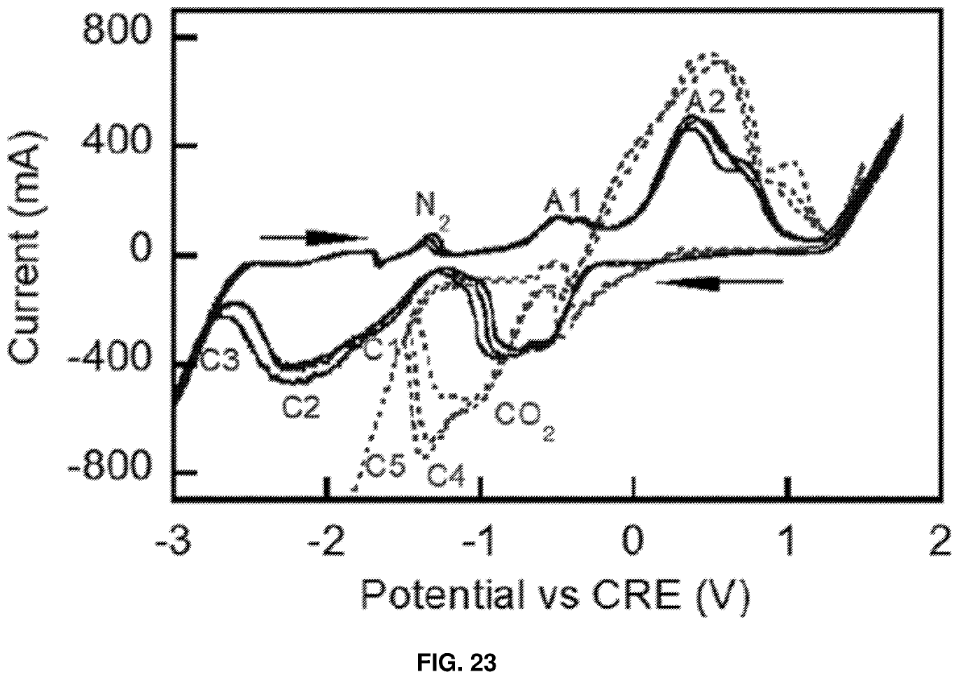

Electrochemical processes occurring during CO₂ electrolysis in molten alkali metal carbonates serving as electrolytic media have been studied extensively by cyclic voltammetry (CV). There have been no such reports on CO₂ electrolysis in molten borate or borate/carbonate blends, which prompted interest in such examination for this example. FIG. 23 shows voltammograms obtained in 3 consecutive scans with a representative borate/carbonate blend.

In FIG. 23, CRE denotes Carbonate Reference Electrode (standard potential vs reference CO₂ oxidation reaction is E^{o}=0 V). In the control experiment conducted under air purge, a systemic −0.131 V shift was observed due to the electrochemical cell parameters and conditions relative to the standard potential (E^{o}₉₀₀=0 V) characteristic of the carbonate ion oxidation in molten carbonates:

CO₃²⁻→CO₂+0.5O₂+2e− (11-3)

Reaction 11-3 is indicated by A1 in FIG. 23. The observed formation of black coating on the anode interior is attributed to the nickel oxidation reaction on the anode-melt interface with the reported standard potential E^{o}₉₀₀=0.697 V:

Ni⁰+CO₃²⁻→NiO+CO₂+2e− (11-4)

Reaction (11-4) is indicated by A2 on the oxidation scan in nitrogen atmosphere in FIG. 23. Lower oxidation currents are observed on the initial scan. Numerous prior studies reported a variety of reduction reactions for nickel compounds (C1) in the presence of neutral gas or carbon dioxide:

NiO+2e−→Ni⁰+O²⁻;E^{o}=−1.50V (11-5)

During the cathodic reduction, at potentials in the −1.2 to −0.7 V range nickel oxide dissolves, forming complexes of nickel and carbonate ions. These complexes are reduced to nickel and carbonate ions; the formed nickel is then oxidized in the following anodic scan, at potentials in the 0.7 to 1.2 V range. The electrochemical processes occurring with nickel and nickel oxide can be considered side reactions, whereas the reactions of electrodeposition of carbon by CO₂ electrolysis are our target product reactions, which will be discussed next. Important deposition potentials of alkali and alkaline earth metals via reactions (11-6) and carbon through reactions (11-7) in their own molten carbonate salts are well-known. Electrochemical deposition of metal:

2M₂CO₃→4M+2CO₂+O₂(M=Li,Na or K) (11-6)

Deposition of carbon via carbonate salt decomposition:

3M₂CO₃→C+3M₂O+2CO₂+O₂ (11-7)

In these experiments with borate/carbonate blends in a nitrogen atmosphere, carbon was produced by cathodic reduction of the carbonate anions (reaction eq (11-7)) formed by dissociation of the molten alkali metal carbonates (indicated as C2 in the −2.3 V range in FIG. 23). Carbon was deposited on galvanized steel cathode in significant quantities, along with deposition of alkali metals and boron. The processes of deposition are indicated by C3 in FIG. 23. In the presence of the Li, Na borate in the borate/carbonate blend (FIG. 23), borate anions (BO₃³⁻) formed by dissociation of the borate in the molten salt can mediate the CO₂ capture and subsequently, lead to enhanced chemisorption: BO₃³⁻+CO₂↔CO₃²⁻+BO₂₋ (11-8) Borate anions also contribute to the metaborate and oxygen anion generation by the molten salt: BO₃³⁻↔BO²⁻+O²⁻ (11-9) Hence, in the presence of the Li, Na borate, the formation of carbonate anions needed for CO₂ electroreduction is augmented, which in turn leads to carbon deposition on the cathode at lower cathodic potentials:

CO₃²⁻+4e−+3BO²⁻→C+2BO₃³⁻ (11-10)

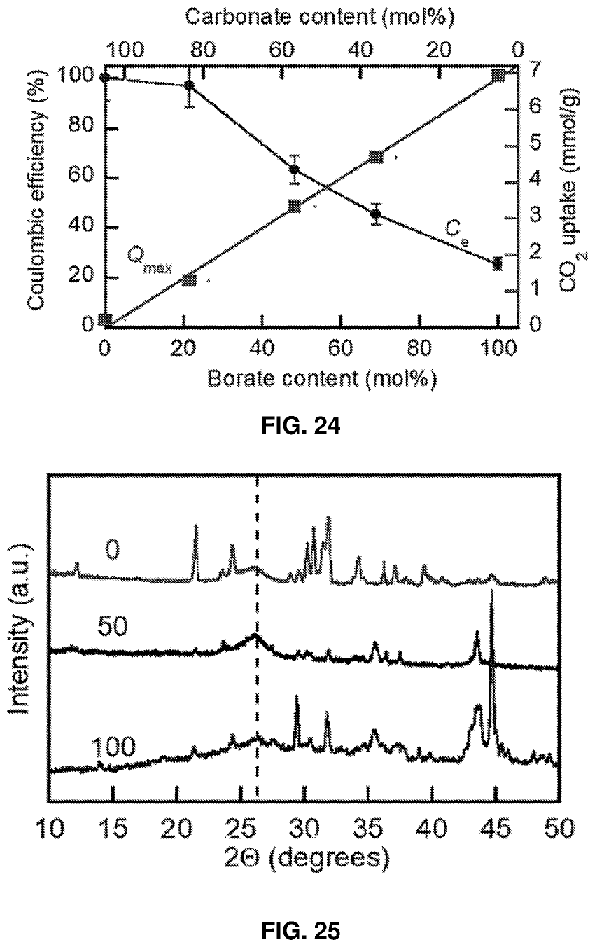

This corresponds to the carbonate electroreduction under CO₂ atmosphere in the −1.4 to −1.2 V range and carbon/metal deposition in the −1.8 to −1.5 V range as indicated by C4 and C5, respectively, in FIG. 23. Electroreduction processes in eq (11-10) (C4) can be seen as transient, as their peak potentials were lowered with the number of scans, indicating that the majority of the dissolved CO₂ was electroreduced. The temperature of the electrolysis process with the borate/carbonate blends was fixed at 550° C., at which the blends exhibited maximum CO₂ uptake at slow rates of heating (FIG. 18). In all experiments, the molten electrolyte was equilibrated with the CO₂ flow prior to the onset of the electrolysis at 550° C. The results of the electrolysis conducted at 550° C. in a series of experiments in which the molten salt composition was varied are shown in FIG. 24. The Coulombic efficiency (Cₑ) results based on the yield of carbon are overlapped with the maximum CO₂ uptake values of the corresponding blend compositions at 550° C. (Qₘₐₓ) measured in TGA experiments. Coulombic efficiency was close to 100% in eutectic Li, K carbonate without the borate added, as expected with galvanized steel cathodes. The yield of carbon in the initially pure Li, K borate at 550° C. was approximately 18% in the borate alone but could be improved by the addition of carbonate Li_{1.24}K_{0.76}CO₃ to the blend (FIG. 24). On the other hand, at 20% of the borate added into carbonate, the Coulombic efficiency of the carbon production was close to 100% while the CO₂ uptake was a lot higher than Qₘₐₓ in pure Li, Na carbonate and sufficient for the high yield of the carbon product.

The opposing Cₑ vs Qₑ trends enable performance optimization via the blend composition to trade off the equilibrium CO₂ sorption (capture) uptake with the yield of carbonaceous product during CO₂ electrolysis as measured by Coulombic efficiency.

### Structure of the Products of CO₂ Electrolysis in Molten Borate/Carbonate Blends

The products of the CO₂ electrolysis were recovered and purified (see Experimental). Elemental analysis for carbon content in the products varied significantly from approximately 20 to 98 wt % depending on the extent of product purification by washing; concentrations of lithium, zinc and nickel varied in the 0.2 to 3.5 wt %, 0.01-2 wt %, and 0.1-1.5 wt % ranges, respectively. FIG. 25 shows a general view of the powder XRD pattern of the products of CO₂ electrolysis collected on the galvanized steel cathodes. The broad peaks centered at 2θ=26-26.2° observed in the XRD patterns of the electrolysis products obtained with either molten Li, Na borate or Li, K borate or their blends were prominent. The (100) crystal peaks are characteristic of multiwall carbon nanotubes and correspond to a d-spacing between graphene sheets (CNT wall layers) of 3.42-3.46 Å. The XRD patterns of the electrolysis products also featured peaks at 2θ=21.3, 30.6, and 31.8°, characteristic of the lithium carbonate admixtures that were not removed from the products in the process of purification. XRD pattern peaks at 2θ=34.4 and 36.2° were due to the presence of ZnO crystals, formed via oxidation of zinc originally present on the galvanized steel cathode surface. Finally, peaks that are present in some products at 2θ=43.5 and 44.7° are due to the NiO crystal lattice and Ni electrodeposited onto the product on the cathode from the molten salt solution, respectively. It has been noted previously that zinc and nickel ion admixtures to the molten carbonates mediate the synthesis and contribute to the yield of carbon nanotubes in the process of CO₂ electrolysis.

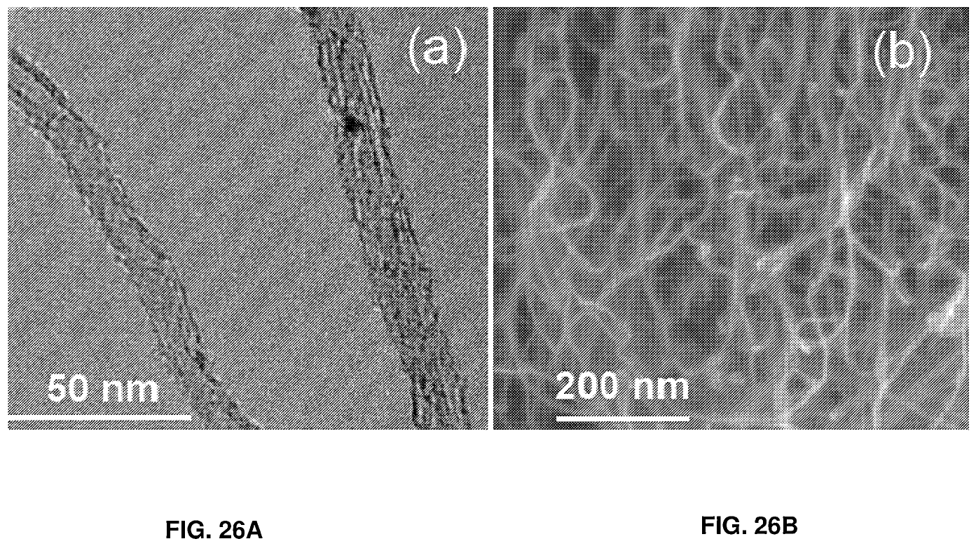

The products of CO₂ electrolysis were further visualized by means of transmission and scanning electron microscopy (TEM and SEM, FIG. 26). Images demonstrated multiwalled CNT (MWCNT) obtained in all borate/carbonate compositions at 550° C. The MWCNT possessed 10-16 graphene layers, with walls approximately 4.5-5 nm thick, and diameters of ˜15.5 nm. Similar MWCNT have been observed previously in the products of CO₂ electrolysis conducted in alkali metal carbonates only, without borates.

### CONCLUSIONS

A family of blended compositions of molten alkali metal borates and carbonates has been examined as reversible CO₂ absorbents as well as media for the CO₂ electrolysis for carbon conversion. Salt structure, reactions with CO₂ and viscosity were studied. Blended borate (Li_{1.5}Na_{1.5}BO₃) and eutectic Li, K carbonate (Li_{1.24}K_{0.76}CO₃) compositions are molten in the 550-600° C. (medium) temperature range. These compositions can be applied as reversible molten absorbents of CO₂, without a significant deterioration of the capture capacity over many cycles of the pressure swing operation. Addition of carbonates to the molten borate lowers overall CO₂ uptake due to the lower sorption capacity of carbonate. However, the addition of eutectic carbonates to the molten Li, Na borate (i) lowers the melt viscosity and enables lowering of the temperature of the pressure swing operation as well as (ii) dramatically accelerates the CO₂ uptake at the initial stage of the cycle, potentially enabling a faster cycling. Blended borate/carbonate compositions were found that possess simultaneous maximum loading capacity for CO₂ and enable maximum product (multiwall carbon nanotube) yield at medium temperatures (550° C.).

The blended borate/carbonate compositions described herein can find utility in processes involving both carbon capture and CO₂ capture/utilization applications. For the reversible capture plant design, the most influential parameters are the cost of CO₂ handling (transport and storage), the cost of electricity, and the energy required for the separation. For the CCUS processes involving both capture and conversion designs, the cost of electricity is the most important factor. Given that a very large amount of electrical energy is required for this design, it must be supplied by renewable energy. The high coulombic efficiency (over 90%, FIG. 24) achieved with some of the borate/carbonate blends is also a very influential factor.

It should be understood that the subject matter defined in the appended claims is not necessarily limited to the specific implementations described above. The specific implementations described above are disclosed as examples only.

1. A composition, comprising:
a sequestration material comprising an alkali metal borate and/or an alkaline earth metal borate,
wherein at least about 0.1% of the total mass of sequestration material is made up of a carbonate.

2. A composition, comprising:
a sequestration material comprising an alkali metal and/or an alkaline earth metal, borate anions, and carbonate anions,
wherein at least 0.1% of the total mass of sequestration material is made up of carbonate anions; and
wherein at least 0.1% of the total mass of the sequestration material is made up of borate anions.

3. The composition of claim 1, wherein at least 10 wt % of the sequestration material is made of the alkali metal borate and/or the alkaline earth metal borate.

4. The composition of claim 1, wherein at least 10 wt % of the sequestration material is made of the carbonate.

5. The composition of claim 2, wherein a molar ratio of carbonate:borate in the sequestration material is greater than or equal to 0.1:1 and less than or equal to 3:1.

6. The composition of claim 1, wherein the sequestration material comprises a mixture of the alkali metal borate and/or the alkaline earth metal borate and a salt comprising the carbonate.

7. The composition of claim 1, wherein the sequestration material comprises a double salt comprising the alkali metal and/or the alkaline earth metal, the borate, and the carbonate.

8. The composition of claim 1, wherein the sequestration material comprises a first salt comprising the alkali metal borate and/or the alkaline earth metal borate and a second salt comprising the carbonate.

9. The composition of claim 1, wherein the sequestration material is capable of sequestering at least 0.5 mmol of carbon dioxide per gram of the sequestration material.

10. The composition of claim 1, wherein at least a portion of the carbonate is formed by sequestering carbon dioxide.

11. The composition of claim 1, wherein the sequestration material is molten at a temperature of below 750° C.

12-13. (canceled)

14. The composition of claim 11, wherein the sequestration material is molten at a temperature of at least 500° C.

15. The composition of claim 1, wherein the sequestration material comprises a salt comprising a mixed salt of lithium and potassium borate in combination with an alkali metal carbonate.

16. The composition of claim 15, wherein at least about 50 to 60% of the total mass of the composition comprises the salt comprising a mixed salt of lithium and potassium borate in combination with the alkali metal carbonate.

17. The composition of claim 1, wherein the sequestration material comprises 55 to 60 mol % of borate relative to carbonate in a molten state of the sequestration material.

18. The composition of claim 1, wherein the sequestration material is in a molten state.

19. The composition of claim 1, wherein the sequestration material is capable of dissolving Li₂O.

20. A method of sequestering gaseous carbon dioxide, comprising:
(a) heating the composition of claim 1 until the composition is molten with the gaseous carbon dioxide to produce a molten alkali metal carbonate;
(b) performing electrolysis between an anode and a cathode in the molten alkali metal carbonate to generate carbon material on the cathode; and
(c) separating some or all of the carbon material from the cathode.

21-22. (canceled)

23. A method, comprising:
within an electrolytic cell comprising a molten material comprising a molten alkali metal borate salt and/or a molten alkaline earth metal borate salt in an amount of at least 10 wt %:
electrolytically forming carbon at a cathode of the electrolytic cell.

24-33. (canceled)

34. A composition comprising:
a sequestration material comprising an alkali metal or alkaline earth metal borate,
wherein at least about 0.1% of the total mass is made up of a salt comprising carbonate and borate and an alkali metal carbonate.

35-44. (canceled)
